(19) United States
(12) Patent Application Publication
(10) Pub. No.: US 2013/0222377 A1
(43) Pub. Date: Aug. 29, 2013

(54) GENERATION OF DEPTH INDICATION MAPS

(71) Applicants: Wilhelmus Hendrikus Alfonsus Bruls, Eindhoven (NL); Remco Theodorus Johannes Muijs, Meteren (NL)

(72) Inventors: Wilhelmus Hendrikus Alfonsus Bruls, Eindhoven (NL); Remco Theodorus Johannes Muijs, Meteren (NL)

(73) Assignee: KONINKLIJKE PHILIPS ELECTRONICS N.V., EINDHOVEN (NL)

(21) Appl. No.: 13/881,091

(22) PCT Filed: Oct. 25, 2011
(86) PCT No.: PCT/IB11/54751

§ 371 Date: Apr. 23, 2013

(30) Foreign Application Priority Data
Nov. 4, 2010 (EP) 10189979.7

(51) Int. Cl. G06T 15/00

(52) U.S. Cl. CPC G06T 15/00
USPC 345/419

(57) ABSTRACT

An approach is provided for generating a depth indication map from an image. The generation is performed using a mapping relating input data in the form of input sets of image spatial positions and a combination of color coordinates of pixel values associated with the image spatial positions to output data in the form of depth indication values. The mapping is generated from a reference image and a corresponding reference depth indication map. Thus, a mapping from the image to a depth indication map is generated on the basis of corresponding reference images. The approach may be used for prediction of depth indication maps from images in an encoder and decoder. In particular, it may be used to generate predictions for a depth indication map allowing a residual image to be generated and used to provide improved encoding of depth indication maps.

### FIELD OF THE INVENTION

The invention relates to generation of depth indication maps and in particular, but not exclusively, to generation of depth indication maps for multi-view images.

### BACKGROUND OF THE INVENTION

Digital encoding of various source signals has become increasingly important over the last decades as digital signal representation and communication increasingly has replaced analogue representation and communication. Continuous research and development is ongoing in how to improve the quality that can be obtained from encoded images and video sequences while at the same time keeping the data rate to acceptable levels.

Furthermore, there is an increasing interest in image and video processing which in addition to the two dimensional image plane further considers depth aspects for the image. For example, three dimensional images are the topic of much research and development. Indeed, three dimensional rendering of images is being introduced to the consumer market in the form of e.g. 3D television, computer displays etc. Such approaches are typically based on generating multiple views that are provided to a user. For example, many current 3D offerings are based on generating stereo views wherein a first image is presented to a viewer's right eye and a second image is presented to the viewer's left eye. Some displays may provide a relatively large number of views that allow the viewer to be provided with suitable views for a plurality of view points. Indeed, such systems may allow a user to look around objects e.g. to see objects that are occluded from the central view point.

Different approaches have been introduced to provide efficient representations for three dimensional scene information. As an example, a separate image may be provided for each view provided to a user. Such an approach may be practical for simple stereo systems wherein predetermined images are presented to a viewers right and left eyes. Thus, such an approach may be relatively suitable for systems that merely provide a predetermined three dimensional experience to a user, such as e.g. when presenting a three dimensional film to a viewer.

However, the approach is not practical for more flexible systems wherein it is desired to provide a viewer with a larger number of views and in particular is not practical for applications where it is desired that the view point of the viewer may be flexibly modified or changed at the point of rendering/presentation. It may also typically be suboptimal for variable baseline stereo image applications where the depth effect is not constant but may be modified. In particular, it may be desirable to vary the strength of the depth effect and this may be very difficult to achieve using fixed images for the left and right ever respectfully and without information of the depth of different objects.

Indeed, stereo representations with fixed left and right views has been standardized in BD 3D (Blu-ray Disc Read-Only Format Part 3 Audio Visual Basic Specifications Version 2.4).

However, formats with fixed views offer little flexibility. Desirable features, such as adaptation for different screen sizes or user-defined adjustment of the strength of the depth sensation to avoid feelings of discomfort, would require additional information to be transmitted. Furthermore, fixed left and right views offer no real provisions for addressing advanced displays such as auto-stereoscopic displays which require more than two views. Furthermore, the approach does not easily support the generation of views for arbitrary viewpoints.

In order to address such problems, it has been proposed to provide a depth map with one or more of the images. A depth map may typically provide depth information for all parts of an image. Thus, the depth map may for each pixel indicate a relative depth of the image object of that pixel. The depth map may allow a high degree of flexibility in the rendering and may for example allow the image to be adapted to correspond to a different view point. Specifically, a shift of the view point will typically result in a shift of the pixels of the image which is dependent on the depth of the pixel.

In some cases, a single image with an associated depth map may allow different views to be generated thereby enabling e.g. three dimensional images to be generated. However, improved performance can often be achieved by providing a plurality of images corresponding to different views. For example, two images corresponding to the left and right eyes of a view may be provided together with one or two depth maps. Indeed, in many applications, a single depth map is sufficient to provide substantial benefits.

However, such approaches also have some inherent disadvantages or challenges.

Indeed, the approach requires that a suitable depth map is available. This may be relatively straightforward for new content and in particular for computer generated images based on three dimensional models. However, for existing content which have not been created with depth information included, it is a very difficult and cumbersome task to generate sufficiently accurate depth maps. Indeed, most approaches for generating depth information for existing content, such as existing pictures or films, are based on a high degree of manual involvement thereby making the generation of depth maps time consuming and expensive.

Also, the inclusion of depth maps inherently require additional data to be distributed and/or stored. Thus, the encoded data rate for images (such as a video sequence) that comprises depth maps is inherently higher than for the same images without the depth maps. It is therefore critical that efficient encoding and decoding of depth maps can be achieved.

Hence, an improved depth map based image system would be desirable. In particular, an improved approach for generating, encoding, and/or decoding depth maps would be advantageous. Specifically, a system allowing increased flexibility, facilitated implementation and/or operation, improved and/or facilitated encoding, decoding and/or generation of depth data, reduced encoding data rates and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of encoding a depth indication map associated with an image, the method comprising: receiving the depth indication map; generating a mapping relating input data in the form of input sets of image spatial positions and a combination of color coordinates of pixel values associated with the image spatial positions to output data in the form of depth indication values in response to a reference image and a corresponding reference depth indication map; and generating an output encoded data stream by encoding the depth indication map in response to the mapping.

The invention may provide improved encoding. For example, it may allow encoding of depth indication maps to be adapted and targeted to specific characteristics. The invention may for example provide an encoding that may allow a decoder to generate a depth indication map. The use of a mapping based on reference images may in particular in many embodiments allow an automated and/or improved adaptation to image and/or depth characteristics without requiring predetermined rules or algorithms to be developed and applied for specific image or depth characteristics.

The image positions that may be considered to be associated with the combination may for a specific input set e.g. be determined as the image positions that meet a neighborhood criterion for the image spatial positions for the specific input set. For example, it may include image positions that are less than a given distance from the position of the input set, that belong to the same image object as the position of the input set, that falls within position ranges defined for the input set etc.

The combination may for example be a combination that combines a plurality of color coordinate values into fewer values, and specifically into a single value. For example, the combination may combine color coordinates (such as RGB values) into a single luminance value. As another example, the combination may combine values of neighboring pixels into a single average or differential value. In other embodiments, the combination may alternatively or additionally be a plurality of values. For example, the combination may be a data set comprising a pixel value for each of a plurality of neighboring pixels. Thus, in some embodiments, the combination may correspond to one additional dimension of the mapping (i.e. in addition to the spatial dimensions) and in other embodiments the combination may correspond to a plurality of additional dimensions of the mapping.

A color coordinate may be any value reflecting a visual characteristic of the pixel and may specifically be a luminance value, a chroma value or a chrominance value. The combination may in some embodiments comprise only one pixel value corresponding to an image spatial position for the input set.

The method may include dynamically generating the mapping. For example, a new mapping may be generated for each image of a video sequence or e.g. for each N^{th} image where N is an integer.

The depth indication map may be a partial or full map corresponding to the image. The depth indication map may comprise values providing depth indications for the image and may specifically comprise a depth indication value for each pixel or group of pixels. The depth indications of the depth indication map may for example be depth (z) coordinates or disparity values. The depth indication map may specifically be a depth disparity map or a depth map.

In some embodiments, occlusion data for the image may also be provided. For example, the image may be represented as a layered image wherein a first layer represents the objects visible from the view point of the image and one or more further layers provide image data for objects that are occluded from this view. Depth indication data may be provided/generated only for the top layer or may also be provided/generated for one or more of the occlusion layers. The occlusion data may be sent in a different layer of the bitstream, i.e. it may be included in an enhancement layer of the output data stream.

In accordance with an optional feature of the invention, the method further comprises receiving the image; predicting a predicted depth indication map from the image in response to the mapping; generating a residual depth indication map in response to the predicted depth indication map and the image; encoding the residual depth indication map to generate encoded depth data; and including the encoded depth data in the output encoded data stream.

The invention may provide improved encoding of depth indication maps. In particular, improved prediction of a depth indication map from an image may be achieved allowing a reduced residual signal and thus more efficient encoding. A data rate of the depth indication map encoding data may be reduced and thus a reduced data rate of the entire signal may be achieved.

The approach may allow prediction to be based on an improved and/or automatic adaptation to the specific relationship between depth indication maps and images.

The approach may in many scenarios allow backwards compatibility with existing equipment which may simply use a base layer comprising an encoding of the input image whereas the depth indication map data is provided in an enhancement layer. Furthermore, the approach may allow a low complexity implementation thereby allowing reduced cost, resource requirements and usage, or facilitated design or manufacturing.

The prediction base image may specifically be generated by encoding the input to generate encoded data; and generating the prediction base image by decoding the encoded data.

The method may comprise generating the output encoded data stream to have a first layer comprising encoded data for the input image and a second layer comprising encoded data for the residual depth indication map. The second layer may be an optional layer and specifically the first layer may be a base layer and the second layer may be an enhancement layer.

The encoding of the residual depth indication map may specifically comprise generating residual data for at least part of the depth indication map by a comparison of the input depth indication map and the predicted depth indication map; and generating at least part of the encoded depth indication map data by encoding the residual data.

In accordance with an optional feature of the invention, each input set corresponds to a spatial interval for each spatial image dimension and at least one value interval for the combination, and the generation of the mapping comprises for each image position of at least a group of image positions of the reference image: determining at least one matching input set having spatial intervals corresponding to the each image position and a value interval for the combination corresponding to a combination value for the each image position in the image; and determining an output depth indication value for the matching input set in response to a depth indication value for the each image position in the reference depth indication map.

This provides an efficient and accurate approach for determining a suitable mapping for depth indication map generation.

In some embodiments the method further comprises determining the output depth indication value for a first input set in response to an averaging of contributions from all depth indication values for image positions of the at least a group of image positions which match the first input set.

In accordance with an optional feature of the invention, the mapping is at least one of: a spatially subsampled mapping; a temporally subsampled mapping; and a combination value subsampled mapping.

This may in many embodiments provide an improved efficiency and/or reduced data rate or resource requirements while still allowing advantageous operation. The temporal subsampling may comprise updating the mapping for a subset of images/maps of a sequence of images/maps. The combination value subsampling may comprise application of a coarser quantization of one or more values of the combination than resulting from the quantization of the pixel values. The spatial subsampling may comprise each input sets covering a plurality of pixel positions.

In accordance with an optional feature of the invention, method further comprises: receiving the image; generating a prediction for the depth indication map from the image in response to the mapping; and adapting at least one of the mapping and a residual depth indication map in response to a comparison of the depth indication map and the prediction.

This may allow an improved encoding and may in many embodiments allow the data rate to be adapted to specific image characteristics. For example, the data rate may be reduced to a level required for a given quality level with a dynamic adaptation of the data rate to achieve a variable minimum data rate.

In some embodiments, the adaptation may comprise determining whether to modify part or all of the mapping. For example, if the mapping results in a predicted depth indication map which deviates more than a given amount from the input depth indication map, the mapping may be partially or fully modified to result in an improved prediction. For example, the adaptation may comprise modifying specific depth indication values provided by the mapping for specific input sets.

In some embodiments, the method may include a selection of elements of at least one of mapping data and residual depth indication map data to include in the output encoded data stream in response to a comparison of the input depth indication map and the predicted depth indication map. The mapping data and/or the residual depth indication map data may for example be restricted to areas wherein the difference between the input depth indication map and the predicted depth indication map exceeds a given threshold.

In accordance with an optional feature of the invention, the input image is the reference image and the reference depth indication map is the depth indication map.

This may in many embodiments allow a highly efficient prediction of a depth indication map from an input image, and may in many scenarios provide a particularly efficient encoding of the depth indication map. The method may further include mapping data characterizing at least part of the mapping in the output encoded data stream.

In accordance with an optional feature of the invention, the method further comprises encoding the image, and the image and the depth indication map are jointly encoded with the image being encoded without being dependent on the depth indication map and the depth indication map being encoded using data from the image, the encoded data being split into separate data streams including a primary data stream comprising data for the image and a secondary data stream comprising data for the depth indication map, wherein the primary and secondary data streams are multiplexed into the output encoded data stream with data for the primary and secondary data streams being provided with separate codes This may provide a particularly efficient encoding of a data stream which may allow improved backwards compatibility. The approach may combine advantages of joint encoding with backwards compatibility.

In accordance with an aspect of the invention, there is provided a method of generating a depth indication map for an image, the method comprising: receiving the image; providing a mapping relating input data in the form of input sets of image spatial positions and a combination of color coordinates of pixel values associated with the image spatial positions to output data in the form of depth indication values, the mapping reflecting a relationship between a reference image and a corresponding reference depth indication map; and generating the depth indication map in response to the image and the mapping.

The invention may allow a particularly efficient approach for generating a depth indication map from an image. In particular, the approach may reduce the requirement for manual intervention and may allow depth indication map generation based on references and automatic extraction of information from such references. The approach may for example allow a depth indication map to be generated which can e.g. be further refined by manual or automated processing.

The method may specifically be a method of decoding a depth indication map. The image may be received as an encoded image which is first decoded after which the mapping is applied to the decoded image to provide a depth indication map. Specifically, the image may be generated by decoding a base layer image of an encoded data stream.

The reference image and a corresponding reference depth indication map may specifically be previously decoded images/maps. In some embodiments, the image may be received in an encoded data stream which may also comprise data characterizing or identifying the mapping and/or the reference image and/or the reference depth indication map.

In accordance with an optional feature of the invention, generating the depth indication map comprises determining at least part of a predicted depth indication map by for each position of at least part of the predicted depth indication map: determining at least one matching input set matching the each position and a first combination of color coordinates of pixel values associated with the each position; retrieving from the mapping at least one output depth indication value for the at least one matching input set; determining a depth indication value for the each position in the predicted depth indication map in response to the at least one output depth indication value; and determining the depth indication map in response to the at least part of the predicted depth indication map.

This may provide a particularly advantageous generation of a depth indication map. In many embodiments, the approach may allow a particularly efficient encoding of depth indication maps. In particular, an accurate, automatically adapting and/or efficient generation of a prediction of a depth indication map from an image can be achieved.

The generation of the depth indication map in response to the at least part of the predicted depth indication map may comprise using the at least part of the predicted depth indication map directly or may e.g. comprise enhancing the at least part of the predicted depth indication map using residual depth indication map data, which e.g. may be comprised in a different layer of an encoded signal than a layer comprising the image.

In accordance with an optional feature of the invention, the image is an image of a video sequence and the method comprises generating the mapping using a previous image of the video sequence as the reference image and a previous depth indication map generated for the previous image as the reference depth indication map.

This may allow an efficient operation and may in particular allow efficient encoding of video sequences with corresponding images and depth indication maps. For example, the approach may allow an accurate encoding based on a prediction of at least part of a depth indication map from an image without requiring any information of the applied mapping to be communicated between the encoder and decoder.

In accordance with an optional feature of the invention, the previous depth indication map is further generated in response to residual depth data for the previous depth indication map relative to predicted depth data for the previous image.

This may provide a particularly accurate mapping and thus improved prediction.

In accordance with an optional feature of the invention, the image is an image of a video sequence, and the method further comprises using a nominal mapping for at least some images of the video sequence.

This may allow particularly efficient encoding for many depth indication maps and may in particular allow an efficient adaptation to different images/maps of a video sequence. For example, a nominal mapping may be used for depth indication maps for which no suitable reference image/map exists, such as e.g. the first image/map following a scene change.

In some embodiments, the video sequence may be received as part of an encoded video signal which further comprises a reference mapping indication of the images for which the reference mapping is used. In some embodiments, the reference mapping indication is indicative of an applied reference mapping selected from a predetermined set of reference mappings. For example, N reference mappings may be predetermined between an encoder and decoder and the encoding may include an indication of which of the reference mappings should be used for the specific depth indication map by the decoder.

In accordance with an optional feature of the invention, the combination is indicative of at least one of a texture, gradient, and spatial pixel value variation for the image spatial positions.

This may provide a particularly advantageous generation of a depth indication map.

In accordance with an optional feature of the invention, the depth indication map is associated with a first view image of a multi-view image and the method further comprises: generating a further depth indication map for a second view image of the multi-view image in response to the depth indication map.

The approach may allow a particularly efficient generation/decoding of multi-view depth indication maps and may allow an improved data rate to quality ratio and/or facilitated implementation. The multi-view image may be an image comprising a plurality of images corresponding to different views of the same scene and a depth indication map may be associated with each view. The multi-view image may specifically be a stereo image comprising a right and left image (e.g corresponding to a viewpoint for the right and left eye of a viewer) and a left and right depth indication map. The first view depth indication map may specifically be used to generate a prediction of the second view depth indication map. In some cases, the first view depth indication map may be used directly as a prediction for the second view depth indication map.

In some embodiments, the step of generating the second view depth indication map comprises: providing a mapping relating input data in the form of input sets of image spatial positions and depth indication values associated with the image spatial positions to output data in the form of depth indication values, the mapping reflecting a relationship between a reference depth indication map for the first view and a corresponding reference depth indication map for the second view; and generating the second view depth indication map in response to the first view depth indication map and the mapping.

This may provide a particularly advantageous approach for generating the second view depth indication map based on the first view depth indication map. In particular, it may allow an accurate mapping or prediction which is based on reference depth indication maps. The generation of the second view depth indication map may be based on an automatic generation of a mapping and may e.g. be based on a previous second view depth indication map and a previous first view depth indication map. The approach may e.g. allow the mapping to be generated independently at an encoder and decoder side and thus allows efficient encoder/decoder prediction based on the mapping without necessitating any additional mapping data being communicated from the encoder to the decoder.

According to an aspect of the invention there is provided device for encoding a depth indication map associated with an image, the device comprising: a receiver for receiving the depth indication map; a mapping generator for generating a mapping relating input data in the form of input sets of image spatial positions and a combination of color coordinates of pixel values associated with the image spatial positions to output data in the form of depth indication values in response to a reference image and a corresponding reference depth indication map; and an output processor for generating an output encoded data stream by encoding the depth indication map in response to the mapping. The device may for example be an integrated circuit or part thereof.

According to an aspect of the invention there is provided an apparatus comprising: the device of the previous paragraph; input connection means for receiving a signal comprising the depth indication map and feeding it to the device; and output connection means for outputting the output encoded data stream from the device.

According to an aspect of the invention there is provided a device for generating a depth indication map for an image, the device comprising: a receiver for receiving the image; a mapping processor for providing a mapping relating input data in the form of input sets of image spatial positions and a combination of color coordinates of pixel values associated with the image spatial positions to output data in the form of depth indication values, the mapping reflecting a relationship between a reference image and a corresponding reference depth indication map; and an image generator for generating the depth indication map in response to the image and the mapping. The device may for example be an integrated circuit or part thereof.

According to an aspect of the invention there is provided an apparatus comprising the device of the previous paragraph; input connection means for receiving the image and feeding it to the device; output connection means for outputting a signal comprising the high depth indication map from the device. The apparatus may for example be a set-top box, a television, a computer monitor or other display, a media player, a DVD or BluRay™ player etc.

According to an aspect of the invention there is provided an encoded signal comprising: an encoded image; and residual depth data for a depth indication map, at least part of the residual depth data being indicative of a difference between a desired depth indication map for the image and a predicted depth indication map resulting from application of a mapping to the encoded image, where the mapping relates input data in the form of input sets of image spatial positions and a combination of color coordinates of pixel values associated with the image spatial positions to output data in the form of depth indication values, the mapping reflecting a relationship between a reference image and a corresponding reference depth indication map.

According to a feature of the invention there is provided a storage medium comprising the encoded signal of the previous paragraph. The storage medium may for example be a data carrier such as a DVD or BluRay™ disc.

A computer program product for executing the method of any of the aspects or features of the invention may be provided. Also, storage medium comprising executable code for executing the method of any of the aspects or features of the invention may be provided.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a transmission system in accordance with some embodiments of the invention;

FIG. 2 is an illustration of an example of an encoder in accordance with some embodiments of the invention;

FIG. 3 is an illustration of an example of a method of encoding in accordance with some embodiments of the invention;

FIGS. 4 and 5 are illustrations of examples of mappings in accordance with some embodiments of the invention;

FIG. 6 is an illustration of an example of an encoder in accordance with some embodiments of the invention;

FIG. 7 is an illustration of an example of an encoder in accordance with some embodiments of the invention;

FIG. 8 is an illustration of an example of a method of decoding in accordance with some embodiments of the invention;

FIG. 9 is an illustration of an example of a prediction of a high dynamic range image in accordance with some embodiments of the invention;

FIG. 10 illustrates an example of a mapping in accordance with some embodiments of the invention;

FIG. 11 is an illustration of an example of a decoder in accordance with some embodiments of the invention;

FIG. 12 is an illustration of an example of an decoder in accordance with some embodiments of the invention;

FIG. 13 is an illustration of an example of a basic encoding module that may be used in encoders in accordance with some embodiments of the invention;

FIG. 14-17 illustrates examples of encoders using the basic encoding module of FIG. 13;

FIG. 18 illustrates an example of a multiplexing of data streams;

FIG. 19 is an illustration of an example of a basic decoding module that may be used in decoders in accordance with some embodiments of the invention; and

FIG. 20-22 illustrates examples of decoders using the basic decoding module of FIG. 18.

### DETAILED DESCRIPTION OF SOME EMBODIMENTS OF THE INVENTION

The following description focuses on embodiments of the invention applicable to encoding and decoding of corresponding images and depth indication maps of video sequences. However, it will be appreciated that the invention is not limited to this application and that the described principles may be applied in many other scenarios. In particular, the principles are not limited to generation of depth indication maps in connection with encoding or decoding.

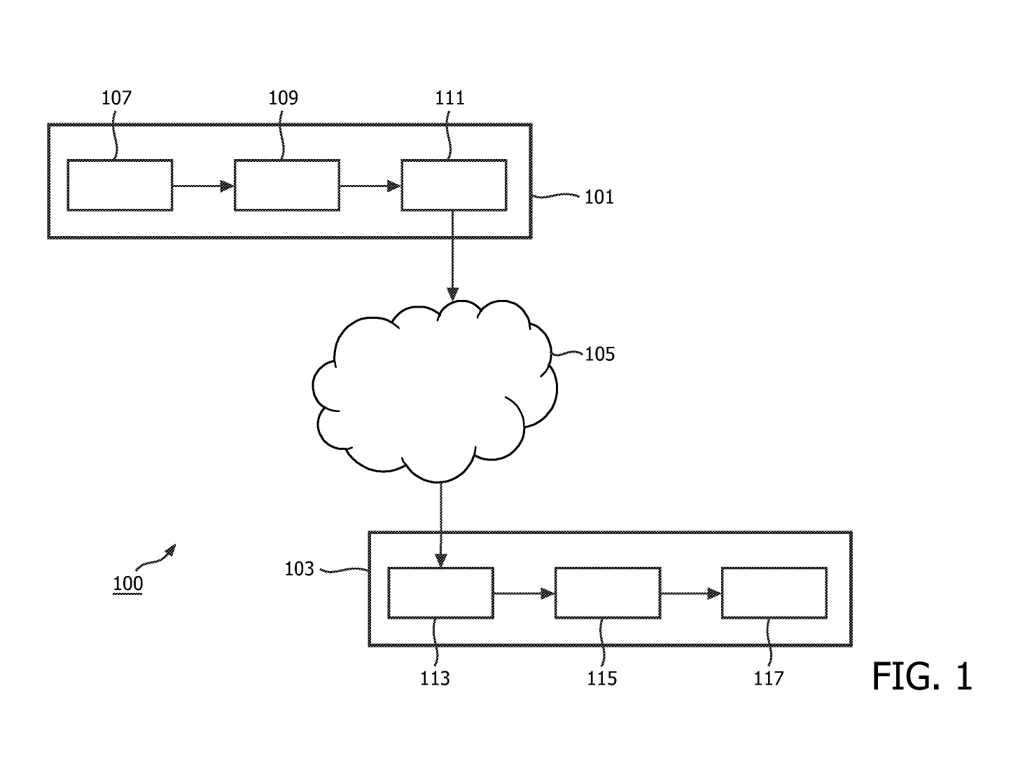

FIG. 1 illustrates a transmission system 100 for communication of a video signal in accordance with some embodiments of the invention. The transmission system 100 comprises a transmitter 101 which is coupled to a receiver 103 through a network 105 which specifically may be the Internet or e.g. a broadcast system such as a digital television broadcast system.

In the specific example, the receiver 103 is a signal player device but it will be appreciated that in other embodiments the receiver may be used in other applications and for other purposes. In the particular example, the receiver 103 may be a display, such as a television, or may be a set top box for generating a display output signal for an external display such as a computer monitor or a television.

In the specific example, the transmitter 101 comprises a signal source 107 which provides a video sequence of images and corresponding depth indication maps. The depth map for an image may comprise depth information for the image. Such depth indications may specifically be a z-coordinate (i.e. a depth value indicating an offset in the direction perpendicular to the image plane (the x-y plane)), a disparity value or any other value providing depth information. The depth indication map may be a full map covering the entire image or may be a partial depth indication map providing depth indications for only one or more areas of the image. The depth indication map may specifically provide a depth value for each pixel of the entire image or for one or more parts of the image.

The signal source 107 may itself generate the image and depth indication map, or may e.g. receive one or both of these from an external source.

In the following an example of a simple image and associated depth indication map will be described. However, in some examples, occlusion data may further be provided for the image and indeed depth indication data, such as a depth indication map, may also be provided for the occlusion data.

The signal source 107 is coupled the encoder 109 which proceeds to encode the video sequences in accordance with an encoding algorithm that will be described in detail later. In particular, the images of the video sequence may be encoded using a conventional encoding standard whereas the depth indication maps will be encoded using prediction based on the corresponding images as will be described later. The encoder 109 is coupled to a network transmitter 111 which receives the encoded signal and interfaces to the communication network 105. The network transmitter may transmit the encoded signal to the receiver 103 through the communication network 105. It will be appreciated that in many other embodiments, other distribution or communication networks may be used, such as e.g. a terrestrial or satellite broadcast system.

The receiver 103 comprises a receiver 113 which interfaces to the communication network 105 and which receives the encoded signal from the transmitter 101. In some embodiments, the receiver 113 may for example be an Internet interface, or a wireless or satellite receiver.

The receiver 113 is coupled to a decoder 115. The decoder 115 is fed the received encoded signal and it then proceeds to decode it in accordance with a decoding algorithm that will be described in detail later. The decoder 115 may specifically generate the decoded image using a conventional decoding algorithm and may decode the depth indication map using prediction from the decoded image as will be described later.

In the specific example where a signal playing function is supported, the receiver 103 further comprises a signal player 117 which receives the decoded video signal (including depth indication maps) from the decoder 115 and presents this to the user using suitable functionality. The signal player 117 may specifically render images from different views based on the decoded image and the depth information as will be known to the skilled person.

The signal player 117 may itself comprise a display that can present the encoded video sequence. Alternatively or additionally, the signal player 117 may comprise an output circuit that can generate a suitable drive signal for an external display apparatus. Thus, the receiver 103 may comprise an input connection means receiving the encoded video sequence and an output connection means providing an output drive signal for a display.

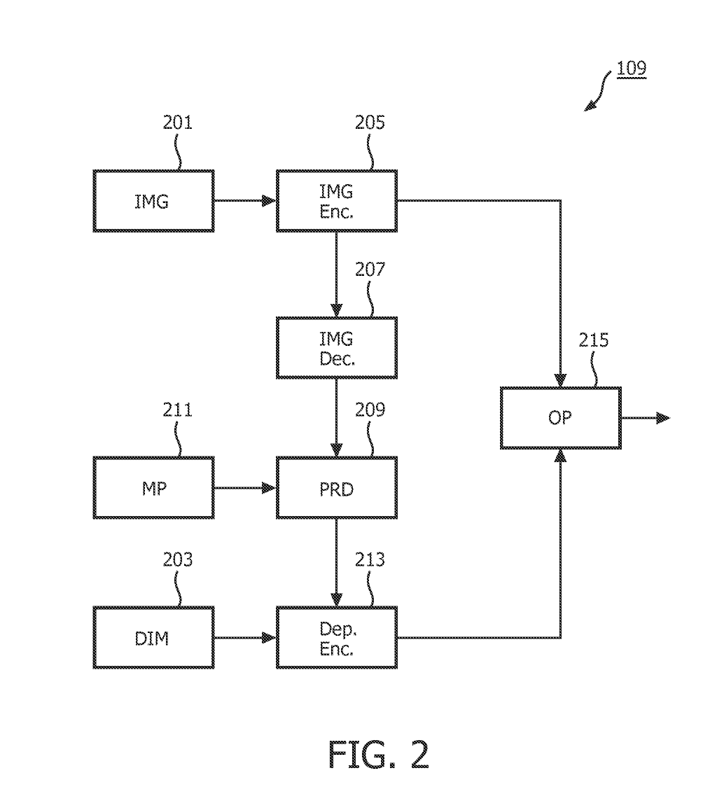

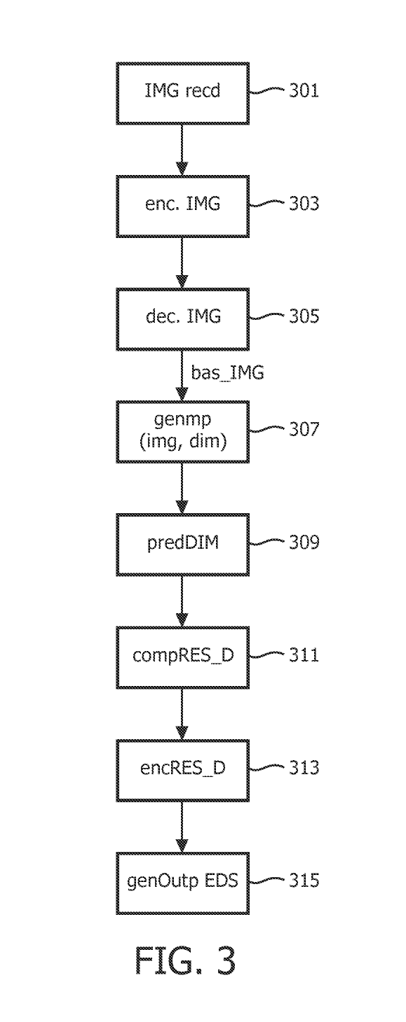

FIG. 2 illustrates an example of the encoder 109 in accordance with some embodiments of the invention. FIG. 3 illustrates an example of a method of encoding in accordance with some embodiments of the invention.

The encoder comprises a receiver 201 for receiving a video sequence comprising input images, and a receiver 203 for receiving a corresponding sequence of depth indication maps.

Initially the encoder 109 performs step 301 wherein an input image of the video sequence is received. The input images are fed to an image encoder 205 which encodes the video images from the video sequence. It will be appreciated that any suitable video or image encoding algorithm may be used and that the encoding may specifically include motion compensation, quantization, transform conversion etc as will be known to the skilled person. Specifically, the image encoder 205 may be a H-264/AVC standard encoder.

Thus, step 301 is followed by step 303 wherein the input image is encoded to generate an encoded image.

The encoder 109 then proceeds to generate a predicted depth map from the input image. The prediction is based on a prediction base image which may for example be the input image itself. However, in many embodiments the prediction base image may be generated to correspond to the image that can be generated by the decoder by decoding the encoded image.

In the example of FIG. 2, the image encoder 205 is accordingly coupled to an image decoder 207 which proceeds to generate the prediction base image by a decoding of encoded data of the image. The decoding may be of the actual output data stream or may be of an intermediate data stream, such as e.g. of the encoded data stream prior to a final non-lossy entropy coding. Thus, the image decoder 207 performs step 305 wherein the prediction base image bas_IMG is generated by decoding the encoded image.

The image decoder 207 is coupled to a predictor 209 which proceeds to generate a predicted depth indication map from the prediction base image. The prediction is based on a mapping provided by a mapping processor 211.

Thus, in the example, step 305 is followed by step 307 wherein the mapping is generated and subsequently step 309 wherein the prediction is performed to generate the predicted depth indication map.

The predictor 209 is further coupled to an depth encoder 213 which is further coupled to the depth indication map receiver 203. The depth encoder 213 receives the input depth indication map and the predicted depth indication map and proceeds to encode the input depth indication map based on the predicted depth indication map.

As a specific low complexity example, the encoding of the depth indication map may be based on generating a residual depth indication map relative to the predicted depth indication map and encoding the residual depth indication map. Thus, in such an example, the depth encoder 213 may proceed to perform step 311 wherein a residual depth indication map is generated in response to a comparison between the input depth indication map and the predicted depth indication map. Specifically, the depth encoder 213 may generate the residual depth indication map by subtracting the predicted depth indication map from the input depth indication map. Thus, the residual depth indication map represents the error between the input depth indication map and that which is predicted based on the corresponding (encoded) image. In other embodiments, other comparisons may be made. For example, a division of the depth indication map by the predicted depth indication map may be employed.

The depth encoder 213 may then perform step 313 wherein the residual depth indication map is encoded to generate encoded residual depth data.

It will be appreciated that any suitable encoding principle or algorithm for encoding the residual depth indication map may be used. Indeed, in many embodiments the predicted depth indication map may be used as one possible prediction out of several. Thus, in some embodiments the depth encoder 213 may be arranged to select between a plurality of predictions including the predicted depth indication map. Other predictions may include spatial or temporal predictions from the same or other depth indication maps. The selection may be based on an accuracy measure for the different predictions, such as on an amount of residual relative to the input depth indication map. The selection may be performed for the whole depth indication map or may for example be performed individually for different areas or regions of the depth indication map.

For example, the depth indication map encoder may be encoded with an H264 encoder, where the depth value is mapped onto a luma value. A conventional H264 encoder may utilize different predictions such as a temporal predication (between frames, e.g. motion compensation) or spatial prediction (i.e. predicting one area of the image from another). In the approach of FIG. 2, such predictions may be supplemented by the depth indication map prediction generated from the image. The H.264 based encoder then proceeds to select between the different possible predictions. This selection is performed on a macroblock basis and is based on selecting the prediction that results in the lowest residual for that macroblock. Specifically, a rate distortion analysis may be performed to select the best prediction approaches for each macroblock. Thus, a local decision is made.

Accordingly, the H264 based encoder may use different prediction approaches for different macroblocks. For each macroblock the residual data may be generated and encoded. Thus, the encoded data for the input HDR image may comprise residual data for each macroblock resulting from the specific selected prediction for that macroblock. In addition, the encoded data may comprise an indication of which prediction approach is used for each individual macroblock.

Thus, the image to depth indication map prediction may provide an additional possible prediction that can be selected by the depth encoder. For some macroblocks, this prediction may result in a lower residual than other predictions and accordingly it will be selected for this macroblock. The resulting residual depth indication map for that block will then represent the difference between the input depth indication map and the predicted depth indication map for that block.

The encoder may in the example use a selection between the different prediction approaches rather than a combination of these, since this would result in the different predictions typically interfering with each other.

The image encoder 205 and the depth encoder 213 are coupled to an output processor 215 which receives the encoded image data and the encoded residual depth data. The output processor 215 then proceeds to perform step 315 wherein an output encoded data stream EDS is generated to include the encoded image data and the encoded residual depth data.

In the example, the generated output encoded data stream is a layered data stream and the encoded image data is included in a first layer with the encoded residual depth data being included in a second layer. The second layer may specifically be an optional layer that can be discarded by decoders or devices that are not compatible with the depth processing. Thus, the first layer may be a base layer with the second layer being an optional layer, and specifically the second layer may be an enhancement or optional layer. Such an approach may allow backwards compatibility while allowing depth capable equipment to utilize the additional depth information. Furthermore, the use of prediction and residual image encoding allows a highly efficient encoding with a low data rate for a given quality.

In the example of FIG. 2, the prediction of the depth indication map is based on a mapping. The mapping is arranged to map from input data in the form of input sets of image spatial positions and a combination of color coordinates of pixel values associated with the image spatial positions to output data in the form of depth indication values.

Thus a mapping, which specifically may be implemented as a look-up-table, is based on input data which is defined by a number of parameters organized in input sets. Thus, the input sets may be considered to be multi-dimensional sets that comprise values for a number of parameters. The parameters include spatial dimensions and specifically may comprise a two dimensional image position, such as e.g. a parameter (range) for a horizontal dimension and a parameter (range) for a vertical dimension. Specifically, the mapping may divide the image area into a plurality of spatial blocks with a given horizontal and vertical extension.

For each spatial block, the mapping may then comprise one or more parameters generated from color coordinates of pixel values. As a simple example, each input set may include a single luminance value in addition to the spatial parameters. Thus, in this case each input set is a three dimensional set with two spatial and one luminance parameters.

For the various possible input sets, the mapping provides an output depth indication value. Thus, the mapping may in the specific example be a mapping from three dimensional input data to a single depth indication (pixel) value.

The mapping thus provides both a spatial and color component (including a luminance only component) dependent mapping to a suitable depth indication value.

The mapping processor 211 is arranged to generate the mapping in response to a reference image and a corresponding reference depth indication map. Thus, the mapping is not a predetermined or fixed mapping but is rather a mapping that may be automatically and flexibly generated/updated based on reference images/depth maps.

The reference images/maps may specifically be images/maps from the video sequences. Thus, the mapping is dynamically generated from images/maps of the video sequence thereby providing an automated adaptation of the mapping to the specific images/maps.

As a specific example, the mapping may be based on the actual image and corresponding depth indication map that are being encoded. In this example, the mapping may be generated to reflect a spatial and color component relationship between the input input and the input depth indication map.

As a specific example, the mapping may be generated as a three dimensional grid of NX×NY×NI bins (input sets). Such a grid approach provides a lot of flexibility in terms of the degree of quantization applied to the three dimensions. In the example, the third (non-spatial) dimension is an intensity parameter which simply corresponds to a luminance value. In the examples below, the prediction of the depth indication map is performed at macro-block level and with 2⁸ intensity bins (i.e. using 8 bit values). For a High Definition image this means that the grid has dimensions of: 120×68×256 bins. Each of the bins corresponds to an input set for the mapping.

For each input pixel at position (x,y) and intensity V in the reference image, the matching bin for position and intensity is first identified.

In the example, each bin corresponds to a spatial horizontal interval, a spatial vertical interval and an intensity interval. The matching bin (i.e. input set) may be determined by means of nearest neighbor interpolation:

Iₓ=[x/sₓ],

I_{y}=[y/s_{y}],

I_{I}=[V/s_{I}],

where Iₓ, I_{y} and I_{I} are the grid coordinates in the horizontal, vertical and intensity directions, respectively, sₓ, s_{y} and s_{I} are the grid spacings (interval lengths) along these dimensions and [ ] denotes the closest integer operator.

Thus, in the example the mapping processor 211 determines a matching input set/bin that has spatial intervals corresponding to the image position for the pixel and an interval of the intensity value interval that corresponds to the intensity value for the pixel in the reference image at the specific position.

The mapping processor 211 then proceeds to determine an output depth indication value for the matching input set/bin in response to a depth indication value for the position in the reference depth indication map.

Specifically, during the construction of the grid, both a depth value D and a weight value W are updated for each new position considered (where D_{R} represents the depth indication value at the position in the reference depth indication map):

D(Iₓ,I₃,I_{I})=D(Iₓ,I_{y},I_{I})+D_{R}(x,y),

W(Iₓ,I_{y},I_{I})=W(Iₓ,I_{y},I_{I})+1.

After all pixels of the reference image/map have been evaluated, the depth indicatin value is normalized by the weight value to result in the output depth indication value B for the bin:

B=D/W,

where the data value B for each value contains an output depth indication pixel value corresponding to the position and input intensity for the specific bin/input set. Thus, the position within the grid is determined by the reference image whereas the data stored in the grid corresponds to the reference depth indication map. Thus, the mapping input sets are determined from the reference image and the mapping output data is determined from the reference depth indication map. In the specific example, the stored output depth indication value is an average of the depth indication values of pixels falling within the input set/bin but it will be appreciated that in other embodiments, other and in particular more advanced approaches may be used.

In the example, the mapping is automatically generated to reflect the depth to spatial and pixel value relationships between the reference image and depth indication map. This is particularly useful for prediction of the depth indication map from the image when the references are closely correlated with the image and depth indication map being encoded. This may particularly be the case if the references are indeed the same image and map as those being encoded. In this case, a mapping is generated which automatically adapts to the specific relationships between the input image and the depth indication map. Thus, whereas the relationship between the image and depth indication map typically cannot be known in advance, the described approach automatically adapts to the relationship without any prior information. This allows an accurate prediction which results in fewer differences relative to the input depth indication map, and thus in a residual image that can be encoded more effectively.

In embodiments where the input image/map being encoded are directly used to generate the mapping, these references will generally not be available at the decoder end. Therefore, the decoder cannot generate the mapping by itself. Accordingly, in some embodiments, the encoder may further be arranged to include data that characterizes at least part of the mapping in the output encoded stream. For example, in scenarios where fixed and predetermined input set intervals (i.e. fixed bins) are used, the encoder may include all the bin output values in the output encoded stream, e.g. as part of the optional layer. Although this may increase the data rate, it is likely to be a relatively low overhead due to the subsampling performed when generating the grid. Thus, the data reduction achieved from using an accurate and adaptive prediction approach is likely to outweigh any increase in the data rate resulting from the communication of the mapping data.

When generating the predicted depth indication map, the predictor 209 may proceed to step through the decoded image one pixel at a time. For each pixel, the spatial position and the intensity value for the pixel in the image is used to identify a specific input set/bin for the mapping. Thus, for each pixel, a bin is selected based on the spatial position and the image value for the pixel. The output depth indication value for this input set/bin is then retrieved and may in some embodiments be used directly as the depth indication value for the pixel. However, as this will tend to provide a certain blockiness due to the spatial subsampling of the mapping, the depth indication value will in many embodiments be generated by interpolation between output depth indication values from a plurality of input bins. For example, the values from neighboring bins (in both the spatial and non-spatial directions) may also be extracted and the depth indication pixel value may be generated as an interpolation of these.

Specifically, the predicted depth indication map can be constructed by slicing in the grid at the fractional positions dictated by the spatial coordinates and the image:

B_{D}=Fᵢₙₜ(B(x/sₓ,y/s_{y},I/s_{I})),

where Fᵢₙₜ denotes an appropriate interpolation operator, such as nearest neighbor or bicubic interpolation.

In many scenarios the images may be represented by a plurality of color components (e.g. RGB or YUV).

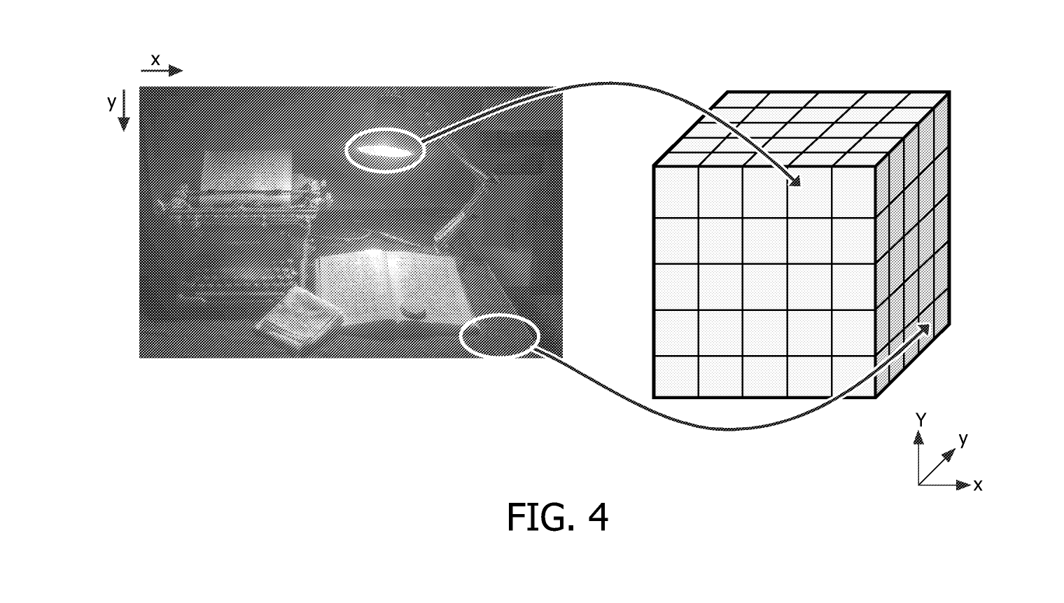

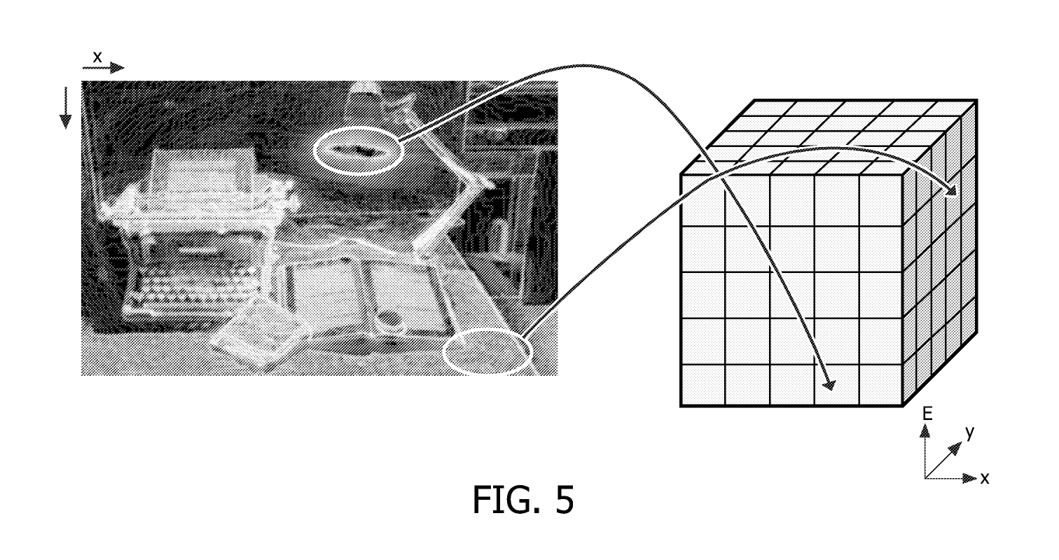

Examples of generation of a mapping are provided in FIGS. 4 and 5. In the examples, the image-depth mapping relation is established using image and depth training references and the position in the mapping table is determined by the horizontal (x) and vertical (y) pixel positions in the image as well as by a combination of image pixel values, such as the luminance (Y) in the example of FIG. 4 and the entropy (E) in the example of FIG. 5. As previously described the mapping table stores the associated depth indication training data at the specified location.

The encoder 115 thus generates an encoded signal which comprises the encoded image. This image may specifically be included in a mandatory or base layer of the encoded bitstream. In addition, data is included that allows an efficient generation of a depth image at the decoder based on the encoded image.

In some embodiments, such data may include or be in the form of mapping data that can be used by the decoder. However, in other embodiments, no such mapping data is included for some or all of the images. Instead, the decoder may itself generate the mapping data from previous images.

The generated encoded signal may further comprise residual depth indication data for the depth indication map where the residual image data is indicative of a difference between a desired depth indication map corresponding to the image and a predicted depth indication map resulting from application of the mapping to the decoded image. The desired depth indication map is specifically the input depth indication map, and thus the residual depth data represents data that can modify the decoder generated depth indication map to more closely correspond to the desired depth indication map, i.e. to the corresponding input depth indication map.

The additional residual depth data may in many embodiments advantageously be included in an optional layer (e.g. an enhancement layer) that may be used by suitably equipped decoders and ignored by legacy decoders that do not have the required functionality.

The approach may for example allow the described mapping based prediction to be integrated in new backwards-compatible video formats. For example, both layers may be encoded using conventional operations of data transformations (e.g. wavelet, DCT) followed by quantization. Intra- and motion-compensated inter-frame predictions can improve the coding efficiency. In such an approach, inter-layer prediction from image to depth complements the other predictions and further improves the coding efficiency of the enhancement layer.

The signal may specifically be a bit stream that may be distributed or communicated, e.g. over a network as in the example of FIG. 1. In some scenarios, the signal may be stored on a suitable storage medium such as a magneto/optical disc. E.g. the signal may be stored on a DVD or Bluray™ disc.

In the previous example, information of the mapping was included in the output bit stream thereby enabling the decoder to reproduce the prediction based on the received image. In this and other cases, it may be particularly advantageous to use a subsampling of the mapping.

Indeed, a spatial subsampling may advantageously be used such that a separate output depth value is not stored for each individual pixel but rather is stored for groups of pixels and in particular regions of pixels. In the specific example a separate output value is stored for each macro-block.

Alternatively or additionally, a subsambling of the input non-spatial dimensions may be used. In the specific example, each input set may cover a plurality of possible intensity values in the images thereby reducing the number of possible bins. Such a subsampling may correspond to applying a coarser quantization prior to the generation of the mapping.

Such spatial or value subsampling may substantially reduce the data rate required to communicate the mapping. However, additionally or alternatively it may substantially reduce the resource requirements for the encoder (and corresponding decoder). For example, it may substantially reduce the memory resource required to store the mappings. It may also in many embodiments reduce the processing resource required to generate the mapping.

In the example, the generation of the mapping was based on the current image and depth indication map, i.e. on the image and corresponding depth indication map being encoded. However, in other embodiments the mapping may be generated using the previous image of the video sequence as the reference image and a previous depth indication map generated for the previous image video sequence as the reference depth indication map (or in some cases the corresponding previous input depth indication map). Thus, in some embodiments, the mapping used for the current image may be based on previous corresponding images and depth indication maps.

As an example the video sequence may comprise a sequence of images of the same scene and accordingly the differences between consecutive images is likely to be low. Therefore, the mapping that is appropriate for one image is highly likely to also be appropriate for the subsequent image. Therefore, a mapping generated using the previous image and depth indication map as references is highly likely to also be applicable to the current image. An advantage of using a mapping for the current image based on a previous image is that the mapping can be independently generated by the decoder as this also has the previous images available (via the decoding of these). Accordingly, no information on the mapping needs to be included, and therefore the data rate of the encoded output stream can be reduced further.

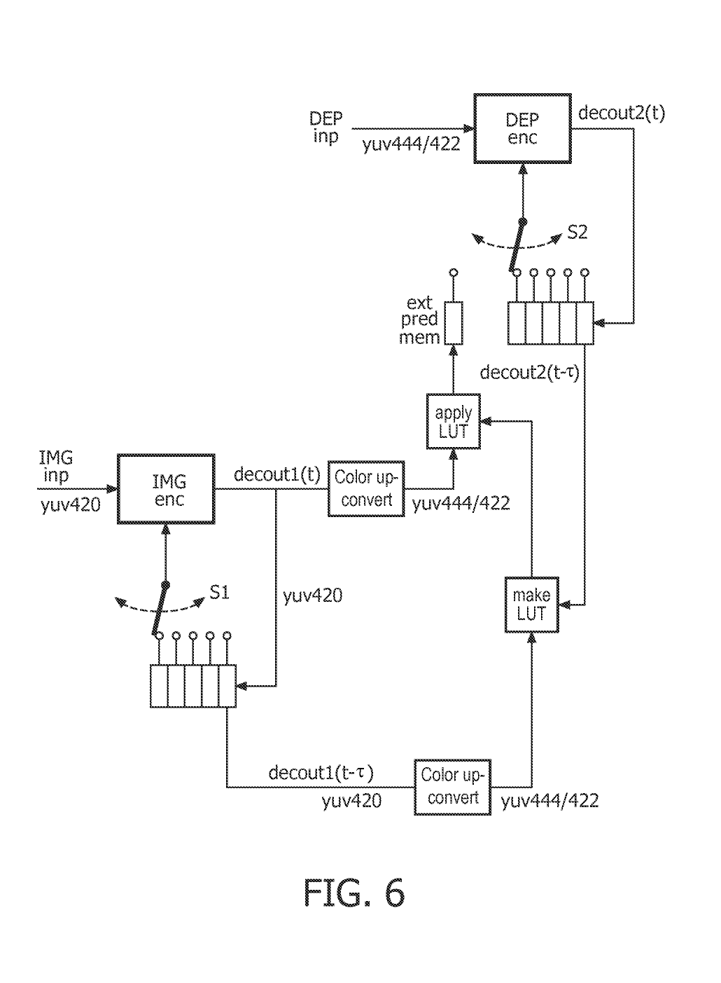

A specific example of an encoder using such an approach is illustrated in FIG. 6. In this example, the mapping (which in the specific example is a Look Up Table, LUT) is constructed on the basis of the previous (delay τ) reconstructed image and the previous reconstructed (delay τ) depth indication map both on the encoder and decoder side. In this scenario no mapping values need to be transmitted from the encoder to the decoder. Rather, the decoder merely copies the depth indication map prediction process using data that is already available to it. Although the quality of the interlayer prediction may be slightly degraded, this will typically be minor because of the high temporal correlation between subsequent frames of a video sequence. In the example, a yuv420 color scheme is used for images and a yuv 444/422 color scheme is used for the mapping and consequently the generation and application of the LUT (mapping) is preceded by a color up-conversion.

It is preferred to keep the delay τ as small as possible in order to increase the likelihood that the images and depth indication maps are as similar as possible. However, the minimum value may in many embodiments depend on the specific encoding structure used as it requires the decoder to be able to generate the mapping from already decoded pictures. Therefore, the optimal delay may depend on the type of GOP (Group Of Pictures) used and specifically on the temporal prediction (motion compensation) used For example for a IPPPP GOP, τ can be a single image delay whereas it from a IBPBP GOP will be at least two images.

In the example, each position of the image contributed to only one input set/bin of the grid. However, in other embodiments the mapping processor may identify a plurality of matching input sets for at least one position of the at least a group of image positions used to generate the mapping. The output depth indication value for all the matching input sets may then be determined in response to the depth indication value for the position in the reference depth indication map.

Specifically, rather than using nearest neighbor interpolation to build the grid, the individual data can also be spread over neighboring bins rather than just the single best matching bin. In this case, each pixel does not contribute to a single bin but contributes to e.g. all its neighboring bins (8 in the case of a 3D grid). The contribution may e.g. be inversely proportional to the three dimensional distance between the pixel and the neighboring bin centers.

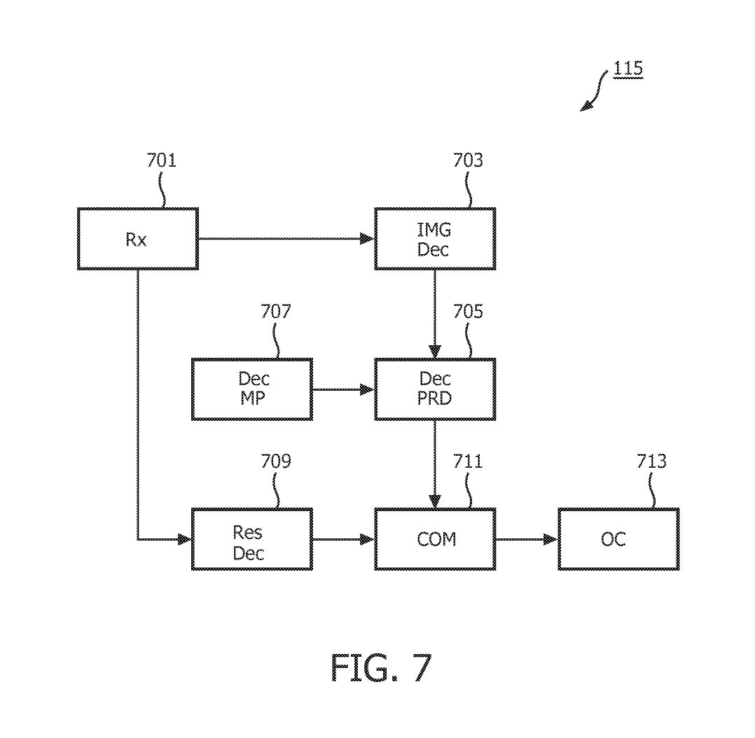

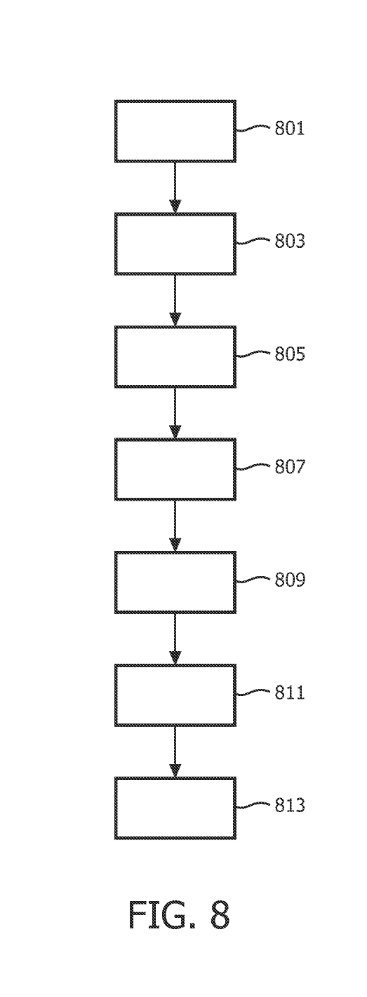

FIG. 7 illustrates an example of a complementary decoder 115 to the encoder of FIG. 2 and FIG. 8 illustrates an example of a method of operation therefor.

The decoder 115 comprises a receive circuit 701 which performs step 801 wherein it receives the encoded data from the receiver 113. In the specific example where image encoded data and residual depth data is encoded in different layers, the receive circuit is arranged to extract and demultiplex the image encoded data and the optional layer data in the form of the residual depth indication map data. In embodiments wherein the information on the mapping is included in the received bitstream, the receive circuit 701 may further extract this data.

The receiver circuit 701 is coupled to an image decoder 703 which receives the encoded image data. It then proceeds to perform step 803 wherein the image is decoded. The image decoder 703 will be complementary to the image encoder 205 of the encoder 109 and may specifically be an H-264/AVC standard decoder.

The image decoder 703 is coupled to a decode predictor 705 which receives the decoded image. The decode predictor 705 is further coupled to a decode mapping processor 707 which is arranged to perform step 805 wherein a mapping is generated for the decode predictor 705.

The decode mapping processor 707 generates the mapping to correspond to that used by the encoder when generating the residual depth data. In some embodiments, the decode mapping processor 707 may simply generate the mapping in response to mapping data received in the encoded data stream. For example, the output data value for each bin of the grid may be provided in the received encoded data stream.

The decode predictor 705 then proceeds to perform step 807 wherein a predicted depth indication map is generated from the decoded image and the mapping generated by the decode mapping processor 707. The prediction may follow the same approach as that used in the encoder.

For brevity and clarity, the example will focus on the simplified example wherein the encoder is based only on the image to depth prediction, and thus where an entire image to depth indication map prediction (and thus an entire residual depth map) is generated. However, it will be appreciated that in other embodiments, the approach may be used with other prediction approaches, such as temporal or spatial predictions. In particular, it will be appreciated that rather than apply the described approach to the whole image, it may be applied only to individual image regions or blocks wherein the image to depth prediction was selected by the encoder.

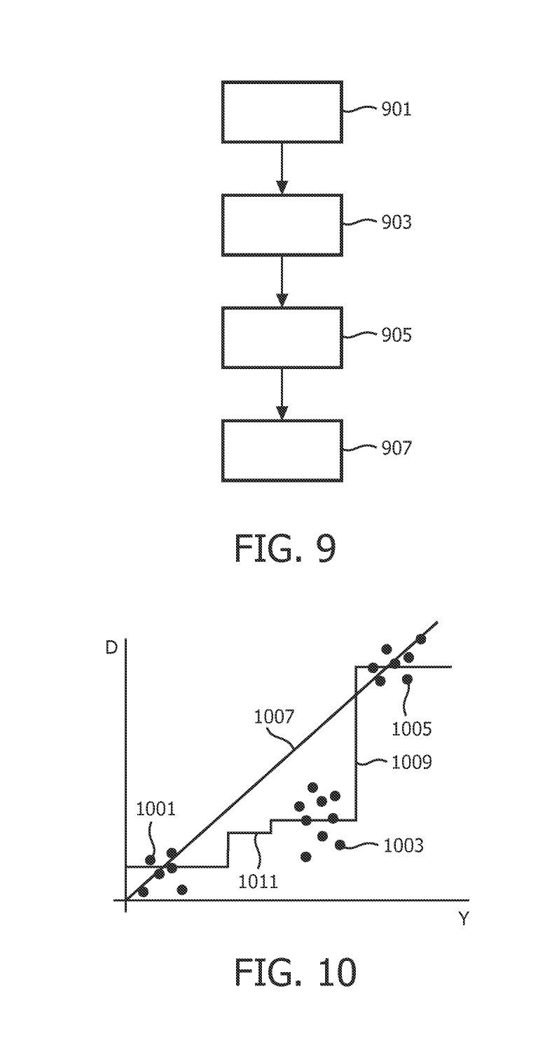

FIG. 9 illustrates a specific example of how a prediction operation may be performed.

In step 901 a first pixel position in the depth indication map image is selected. For this pixel position an input set for the mapping is then determined in step 903, i.e. a suitable input bin in the grid is determined. This may for example be determined by identifying the grid covering the spatial interval in which the position falls and the intensity interval in which the decoded pixel value of the decoded image falls. Step 903 is then followed by step 905 wherein an output depth value for the input set is retrieved from the mapping. E.g. a LUT may be addressed using the determined input set data and the resulting output data stored for that addressing is retrieved.

Step 905 is then followed by step 907 wherein the depth value for the pixel is determined from the retrieved output. As a simple example, the depth value may be set to the retrieved depth indication value. In more complex embodiments, the pixel depth value may be generated by interpolation of a plurality of output depth values for different input sets (e.g. considering all neighbor bins as well as the matching bin).

This process may be repeated for all positions in the depth indication map and thereby resulting in a predicted depth indication map being generated.

The decoder 115 then proceeds to generate an output depth indication map based on the predicted depth indication map.

In the specific example, the output depth indication map is generated by taking the received residual depth indication data into account. Thus the receive circuit 701 is coupled to a residual decoder 709 which receives the residual depth indication data and which proceeds to perform step 809 wherein the residual depth indication data is decoded to generate a decoded residual image.

The residual decoder 709 is coupled to a combiner 711 which is further coupled to the decode predictor 705. The combiner 711 receives the predicted depth indication map and the decoded residual depth indication map and proceeds to perform step 811 wherein it combines the two maps to generate the output depth indication map. Specifically, the combiner may add depth values for the two images on a pixel by pixel basis to generate the output depth indication map.

The combiner 711 is coupled to an output circuit 713 which performs step 813 in which an output signal is generated. The output signal may for example be a display drive signal which can drive a suitable display, such as a television, to present the image or generate alternative images based on the image and the depth indication map. For example, images corresponding to different viewpoints may be generated.

In the specific example, the mapping was determined on the basis of data included in the encoded data stream. However, in other embodiments, the mapping may be generated in response to previous images/maps that have been received by the decoder, such as e.g. the previous image and depth indication map of the video sequence. For this previous image, the decoder will have a decoded image resulting from the image decoding and this may be used as the reference image. In addition, a depth indication map has been generated by prediction followed by further correction of the predicted depth indication map using the residual depth indication map. Thus, the generated depth indication map closely corresponds to the input depth indication map of the encoder and may accordingly be used as the reference depth indication map. Based on these two reference images, the exact same approach as that used by the encoder may be used to generate a mapping by the decoder. Accordingly, this mapping will correspond to that used by the encoder and will thus result in the same prediction (and thus the residual depth indication data will accurately reflect the difference between the decoder predicted depth indication map and the input depth indication map at the encoder).

The approach thus provides a backwards compatible depth encoding starting from a standard image encoding.

The approach uses a prediction of the depth indication map from the available image data, so that the required residual depth information is reduced.

The approach uses an improved characterization of the mapping from different image values to depth values automatically taking into account the specifics of the image/scene.

The described approach may provide a particularly efficient adaptation of the mapping to the specific local characteristics and may in many scenarios provide a particularly accurate prediction. This may be illustrated by the example of FIG. 10 which illustrates relationships between the luminance for the image Y and the depth D in the corresponding depth indication map. FIG. 10 illustrates the relationship for a specific macro-block which happens to include elements of three different objects. As a consequence the relations (indicated by dots) between pixel luminances and depth are located in three different clusters 1001, 1003, 1005.

Straightforward applications would merely perform a linear regression on the relationship thereby generating a linear relationship between the luminance values and the depth values, such as e.g. the one indicated by the line 1007. However, such an approach will provide relatively poor mapping/prediction for at least some of the values, such as those belonging to the image object of cluster 1003.

In contrast, the approach described above will generate a much more accurate mapping such as the one indicated by line 1009. This mapping will much more accurately reflect the characteristics and suitable mapping for all of the clusters and will thus result in an improved mapping. Indeed, the mapping may not only provide accurate results for luminances corresponding to the clusters but can also accurately predict relationships for luminances inbetween, such as for the interval indicated by 1011. Such mappings can be obtained by interpolation.

Furthermore, such accurate mapping information can be determined automatically by simple processing based on reference images/maps (and in the specific case based on two reference macro blocks). In addition, the accurate mapping can be determined independently by an encoder and a decoder based on previous images and thus no information of the mapping needs to be included in the data stream. Thus, overhead of the mapping may be minimized.

In the previous example, the approach was used as part of a decoder for an image and depth indication map. However, it will be appreciated that the principles may be used in many other applications and scenarios. For example, the approach may be used to simply generate a depth indication map from an image. For example, suitable local reference images and depth indication maps may be selected locally and used to generate a suitable mapping. The mapping may then be applied to the image to generate a depth indication map (e.g. using interpolation). The resulting depth indication map may then be used to render the image e.g. with a changed viewpoint.

Also, it will be appreciated that the decoder in some embodiments may not consider any residual data (and thus that the encoder need not generate the residual data). Indeed, in many embodiments the depth indication map generated by applying the mapping to the decoded image may be used directly as the output depth indication map without requiring any further modification or enhancement.

The described approach may be used in many different applications and scenarios and may for example be used to dynamically generate real-time depth indication map signals from image video signals. For example, the decoder 115 may be implemented in a set-top box or other apparatus having an input connector receiving the video signal and an output connector outputting a video signal with an associated depth indication map signal.

As a specific example, a video signal as described may be stored on a Bluray™ disc which is read by a Bluray™ player. The Bluray™ player may be connected to the set-top box via an HDMI cable and the set-top box may then generate the depth indication map. The set-top box may be connected to a display (such as a television) via another HDMI connector.

In some scenarios, the decoder or depth indication map generation functionality may be included as part of a signal source, such as a Bluray™ player or other media player. As another alternative, the functionality may be implemented as part of a display, such as a computer monitor or television. Thus, the display may receive an image stream that can be modified to provide different images based on locally generated depth indication maps. Hence, a signal source, such as a media player, or a display, such as a computer monitor or television, which delivers a significantly improved user experience can be provided.

In the specific described examples, the input data for the mapping simply consisted in two spatial dimensions and a single pixel value dimension representing an intensity value that may e.g. correspond to a luminance value for the pixel or to a color channel intensity value.

However, more generally the mapping input may comprise a combination of color coordinates for pixels of an image. Each color coordinate may simply correspond to one value of a pixel, such as to one of the R, G and B values of an RGB signal or to one of the Y, U, V values of a YUV signal. In some embodiments, the combination may simply correspond to the selection of one of the color coordinate values, i.e. it may correspond to a combination wherein all color coordinates apart from the selected color coordinate value are weighted by zero weights.

In other embodiments, the combination may be of a plurality of color coordinates for a single pixel. Specifically, the color coordinates of an RGB signal may simply be combined to generate a luminance value. In other embodiments, more flexible approaches may be used such as for example a weighted luminance value where all color channels are considered but the color channel for which the grid is developed is weighted higher than the other color channels.

In some embodiments, the combination may take into account pixel values for a plurality of pixel positions. For example, a single luminance value may be generated which takes into account not only the luminance of the pixel for the position being processed but which also takes into account the luminance for other pixels.

Indeed, in some embodiments, combination values may be generated which do not only reflect characteristics of the specific pixel but also characteristics of the locality of the pixel and specifically of how such characteristics vary around the pixel.

As an example, a luminance or color intensity gradient component may be included in the combination. E.g. the combination value may be generated taking into account the difference between luminance of the current pixel value and the luminances of each of the surrounding pixels. Further the difference to the luminances to the pixels surrounding the surrounding pixels (i.e. the next concentric layer) may be determined. The differences may then be summed using a weighted summation wherein the weight depends on the distance to the current pixel. The weight may further depend on the spatial direction, e.g. by applying opposite signs to differences in opposite directions. Such a combined difference based value may be considered to be indicative of a possible luminance gradient around the specific pixel.

Thus, applying such a spatially enhanced mapping may allow the depth indication map generated from an image to take spatial variations into account thereby allowing it to more accurately reflect such spatial variations.

As another example, the combination value may be generated to reflect a texture characteristic for the image area including the current pixel position. Such a combination value may e.g. be generated by determining a pixel value variance over a small surrounding area. As another example, repeating patterns may be detected and considered when determining the combination value.

Indeed, in many embodiments, it may be advantageous for the combination value to reflect an indication of the variations in pixel values around the current pixel value. For example, the variance may directly be determined and used as an input value.

As another example, the combination may be a parameter such as a local entropy value. The entropy is a statistical measure of randomness that can e.g. be used to characterize the texture of the input image (apart from this example, other texture or object identification measures may be used, e.g. a summarization of nearby edge and corner measures (which may have a further codification based on (coarse) direction and distance from the present position, e.g. indicating that a local point or pixel region is on the left of a jagged edge), which may all contribute to the prediction, whether in separate or aggregate mappings/lookup tables). An entropy value H may for example be calculated as:

$$H ( I ) = - {\sum }_{j = 1}^{n} p ( {I}_{j} ) {log}_{b} p ( {I}_{j} ) ,$$

where p( ) denotes the probability density function for the pixel values Iⱼ in the image I. This function can be estimated by constructing the local histogram over the neighborhood being considered (in the above equation, n neighboring pixels). The base of the logarithm b is typically set to 2.

It will be appreciated that in embodiments wherein a combination value is generated from a plurality of individual pixel values, the number of possible combination values that are used in the grid for each spatial input set may possibly be larger than the total number of pixel value quantization levels for the individual pixel. E.g. the number of bins for a specific spatial position may exceed the number of possible discrete luminance values that a pixel can attain. However, the exact quantization of the individual combination value, and thus the size of the grid, is best optimized for the specific application.

It will be appreciated that the generation of the depth indication map from the image can be in response to various other features, parameters and characteristics.

For example, the encoder and/or decoder may comprise functionality for extracting and possible identifying image objects and may adjust the mapping in response to characteristics of such objects. For example, various algorithms are known for detection of faces in an image and such algorithms may be used to adapt the mapping in areas that are considered to correspond to a human face. Other example features that could be considered included sharpness, contrast and color saturation metrics. All these features generally decrease with increasing depth, and therefore tend to correlate fairly well with depth.

Thus, in some embodiments the encoder and/or decoder may comprise means for detecting image objects and means for adapting the mapping in response to image characteristics of the image objects. In particular, the encoder and/or decoder may comprise means for performing face detection and means for adapting the mapping in response to face detection (this can be implemented e.g. by adding a range of “face luminances” above the picture luminances range in the LUT, and although those luminances may also occur somewhere in the picture, by means of the face detection they get another meaning). For example, it may be assumed that in the specific image faces are more likely to be foreground objects than background objects.

It will be appreciated that the mapping may be adapted in many different ways. As a low complexity example, different grids or look-up tables may simply be used for different areas. Thus, the encoder/decoder may be arranged to select between different mappings in response to image characteristics for an image object.

Other means of adapting the mapping can be envisaged. For example, in some embodiments the input data sets may be processed prior to the mapping. For example, a parabolic function may be applied to colour values prior to the table look-up. Such a preprocessing may possibly be applied to all input values or may e.g. be applied selectively. For example, the input values may only be pre-processed for some areas or image objects, or only for some value intervals. For example, the preprocessing may be applied only to colour values that fall within a skin tone interval and/or to areas that are designated as likely to correspond to a face. Such an approach may allow a more accurate modelling of human faces.

Alternatively or additionally, post-processing of the output depth values may be applied. Such post-processing may similarly be applied throughout or may be selectively applied. For example, it may only be applied to output values that correspond to skin tones or may only be applied to areas considered to correspond to faces. In some systems, the post-processing may be arranged to partially or fully compensate for a pre-processing. For example, the pre-processing may apply a transform operation with the post-processing applying the reverse transformation.

As a specific example, the pre-processing and/or post-processing may comprise a filtering of (one or more) of the input/output values. This may in many embodiments provide improved performance and in particular the mapping may often result in improved prediction. For example the filtering may result in reduced banding in the depth domain.

In some embodiments the mapping may be non-uniformly subsampled. The mapping may specifically be at least one of a spatially non-uniform subsampled mapping; a temporally non-uniform subsampled mapping; and a combination value non-uniform subsampled mapping.

The non-unform subsampling may be a static non-uniform subsampling or the non-uniform subsampling may be adapted in response to e.g. a characteristics of the combinations of colour coordinates or of an image characteristic.

For example, the colour value subsampling may be dependent on the colour coordinate values. This may for example be static such that bins for colour values corresponding to skin tones may cover much smaller colour coordinate value intervals than for colour values that cover other colours.

As another example, a dynamic spatial subsampling may be applied wherein a much finer subsampling of areas that are considered to correspond to faces is used than for areas that are not considered to correspond to faces. It will be appreciated that many other non-uniform subsampling approaches can be used.

In the previous examples, a three dimensional mapping/grid has been used. However, in other embodiments an N dimensional grid may be used where N is an integer larger than three. In particular, the two spatial dimensions may be supplemented by a plurality of pixel value related dimensions.

Thus, in some embodiments the combination may comprise a plurality of dimensions with a value for each dimension. As a simple example, the grid may be generated as a grid having two spatial dimensions and one dimension for each color channel. E.g. for an RGB image, each bin may be defined by a horizontal position interval, a vertical position interval, an R value interval, a G value interval and a B value interval).

As another example, the plurality of pixel value dimensions may additionally or alternatively correspond to different spatial dimensions. For example, a dimension may be allocated to the luminance of the current pixel and to each of the surrounding pixels.

Such, multi-dimensional grids may provide additional information that allows an improved prediction and in particular allows the depth indication map to more closely reflect relative differences between pixels.

In some embodiments, the encoder may be arranged to adapt the operation in response to the prediction.

For example, the encoder may generate the predicted depth indication map as previously described and may then compare this to the input depth indication map. This may e.g. be done by generating the residual depth indication map and evaluating this map. The encoder may then proceed to adapt the operation in dependence on this evaluation, and may in particular adapt the mapping and/or the residual depth indication map depending on the evaluation.

As a specific example, the encoder may be arranged to select which parts of the mapping to include in the encoded data stream based on the evaluation. For example, the encoder may use a previous set of images/maps to generate the mapping for the current image. The corresponding prediction based on this mapping may be determined and the corresponding residual depth indication map may be generated. The encoder may then evaluate the residual depth indication map to identify areas in which the prediction is considered sufficiently accurate and areas in which the prediction is considered to not be sufficiently accurate. E.g. all pixels for which the residual depth indication map value is lower than a given predetermined threshold may be considered to be predicted sufficiently accurately. Therefore, the mapping values for such areas are considered sufficiently accurate, and the grid values for these values can be used directly by the decoder. Accordingly, no mapping data is included for input sets/bins that span only pixels that are considered to be sufficiently accurately predicted.

However, for the bins that correspond to pixels which are not sufficiently accurately predicted, the encoder may proceed to generate new mapping values based on using the current set of image/map as the reference. As this mapping information cannot be recreated by the decoder, it is included in the encoded data. Thus, the approach may be used to dynamically adapt the mapping to consist of data bins reflecting previous images/maps and data bins reflecting the current image/map. Thus, the mapping is automatically adapted to be based on the previous images/maps when this is acceptable and the current image/map when this is necessary. As only the bins generated based on the current image/map need to be included in the encoded output stream, an automatic adaptation of the communicated mapping information is achieved.

Thus in some embodiments, it may be desirable to transmit a better (not decoder-side constructed) image to depth mapping for some regions of the image, e.g. because the encoder can detect that for those regions, the depth indication map prediction is not sufficiently good, e.g. because of critical object changes, or because the object is really critical (such as a face).

In some embodiments, a similar approach may alternatively or additionally be used for the residual depth indication map. As a low complexity example, the amount of residual depth indication data that is communicated may be adapted in response to a comparison of the input depth indication map and the predicted depth indication map. As a specific example, the encoder may proceed to evaluate how significant the information in the residual depth indication map is. For example, if the average value of the values of the residual depth indication map is less than a given threshold, this indicates that the predicted image is close to the input depth indication map. Accordingly, the encoder may select whether to include the residual depth indication map in the encoded output stream or not based on such a consideration. E.g. if the average residual depth value is below a threshold, no encoding data for the residual image is included and if it is above the threshold, encoding data for the residual depth indication map is included.

In some embodiments a more nuanced selection may be applied wherein residual depth indication data is included for areas in which the depth indication values on average are above a threshold but not for image areas in which the depth indication values on average are below the threshold. The image areas may for example have a fixed size or may e.g. be dynamically determined (such as by a segmentation process).

In some embodiments, the encoder may further generate the mapping to provide desired effects. For example, in some embodiments, the mapping may not be generated to provide the most accurate prediction but rather may be generated to alternatively or additionally impart a desired effect. For example, the mapping may be generated such that the prediction also provides e.g. a depth enhancement effect such that the rendering of the image will result in a perceived higher depth (i.e. larger perceived distance between foreground and background objects). Such a desired effect may for example be applied differently in different areas of the image. For example, image objects may be identified and different approaches for generating the mapping may be used for the different areas. In particular, some areas corresponding to image objects may be moved further forwards or backwards in the picture.

Indeed, in some embodiments, the encoder may be arranged to select between different approaches for generating the mapping in response to image characteristics, and in particular in response to local image characteristics.

In the examples, the mapping has been based on an adaptive generation of a mapping based on sets of images and depth indication maps. In particular, the mapping may be generated based on previous image and depth indication maps as this does not require any mapping information to be included in the encoded data stream. However, in some cases this is not suitable, e.g. for a scene change, the correlation between a previous image and the current image is unlikely to be very high. In such a case, the encoder may switch to include a mapping in the encoded output data. E.g. the encoder may detect that a scene chance occurs and may accordingly proceed to generate the mapping for the image(s) immediately following the scene change based on the current image and depth indication map themselves. The generated mapping data is then included in the encoded output stream. The decoder may proceed to generate mappings based on previous images/maps except for when explicit mapping data is included in the received encoded bit stream in which case this is used.

In some embodiments, the decoder may use a reference mapping for at least some images of the video sequence. The reference mapping may be a mapping that is not dynamically determined in response to image and depth indication map sets of the video sequence. A reference mapping may be a predetermined mapping.

For example, the encoder and decoder may both have information of a predetermined default mapping that can be used to generate a depth indication map from an image. Thus, in an embodiment where dynamic adaptive mappings are generated from previous images, the default predetermined mapping may be used when such a determined mapping is unlikely to be an accurate reflection of the current image. For example, after a scene change, a reference mapping may be used for the first image(s).

In such cases, the encoder may detect that a scene change has occurred (e.g. by a simple comparison of pixel value differences between consecutive images) and may then include a reference mapping indication in the encoded output stream which indicates that the reference mapping should be used for the prediction. It is likely that the reference mapping will result in a reduced accuracy of the predicted depth indication map. However, as the same reference mapping is used by both the encoder and the decoder, this results only in increased values (and thus increased data rate) for the residual depth indication map.

In some embodiments, the encoder and decoder may be able to select the reference mapping from a plurality of reference mappings. Thus rather than using just one reference mapping, the system may have shared information of a plurality of predetermined mappings. In such embodiments, the encoder may generate a predicted depth indication map and a corresponding residual image depth indication map all possible reference mappings. It may then select the one that results in the smallest residual depth indication map (and thus in the lowest encoded data rate). The encoder may include a reference mapping indicator which explicitly defines which reference mapping has been used in the encoded output stream. Such an approach may approve the prediction and thus reduce the data rate required for communicating the residual depth indication map in many scenarios.

Thus, in some embodiments a fixed LUT (mapping) may be used (or one selected from a fixed set and with only the corresponding index being transmitted) for the first frame or the first frame after a scene change. Although, the residual for such frames will generally be higher, this is typically outweighed by the fact that no mapping data has to be encoded.

In the examples, the mapping is thus arranged as a multidimensional map having two spatial image dimensions and at least one combination value dimension. This provides a particularly efficient structure.

In some embodiments, a multi-dimensional filter may be applied to the multidimensional map, the multi-dimensional filter including at least one combination value dimension and at least one of the spatial image dimensions. Specifically a moderate multi-dimensional low-pass filter may in some embodiments be applied to the multi-dimensional grid. This may in many embodiments result in an improved prediction and thus reduced data rate. Specifically, it may improve the prediction quality for some signals, such as smooth intensity gradients that typically result in contouring artifacts.

In the previous description a single depth indication map has been generated from an image. However, multi-view capturing and rendering of scenes has been of increasing interest. For example, three dimensional (3D) television is being introduced to the consumer market. As another example, multi-view computer displays allowing a user to look around objects etc have been developed.

A multi-view image may thus comprise a plurality of images of the same scene captured or generated from different view points. The following will focus on a description for a stereo-view comprising a left and right (eye) view of a scene. However, it will be appreciated that the principles apply equally to views of a multi-view image comprising more than two images corresponding to different directions and that in particular the left and right images may be considered to be two images for two views out of the more than two images/views of the multi-view image.

In many scenarios it is accordingly desirable to be able to efficiently generate, encode or decode multi-view images and this may in many scenarios be achieved by one image of the multi-view image being dependent on another image.

Multi view images may in some cases be represented by only one depth indication map ie a depth indication map may be provided for only one of the multi view images. However, in other examples, a depth indication map may be provided for all or some of the images in the multi view image. Specifically, a left depth indication map may be provided for the left image and a right depth indication map may be provided for the right image.

In such scenarios, the previously described approach for generating/predicting a depth indication map may be applied individually for each individual image of the multi-view image. Specifically, the left depth indication map may be generated/predicted from a mapping of the left image and the right depth indication map may be generated/predicted from the right image.

However, alternatively or additionally the depth indication map for one view may be generated or predicted from the depth indication map of another view. E.g. the right depth indication map may be generated or predicted from the left depth indication map.

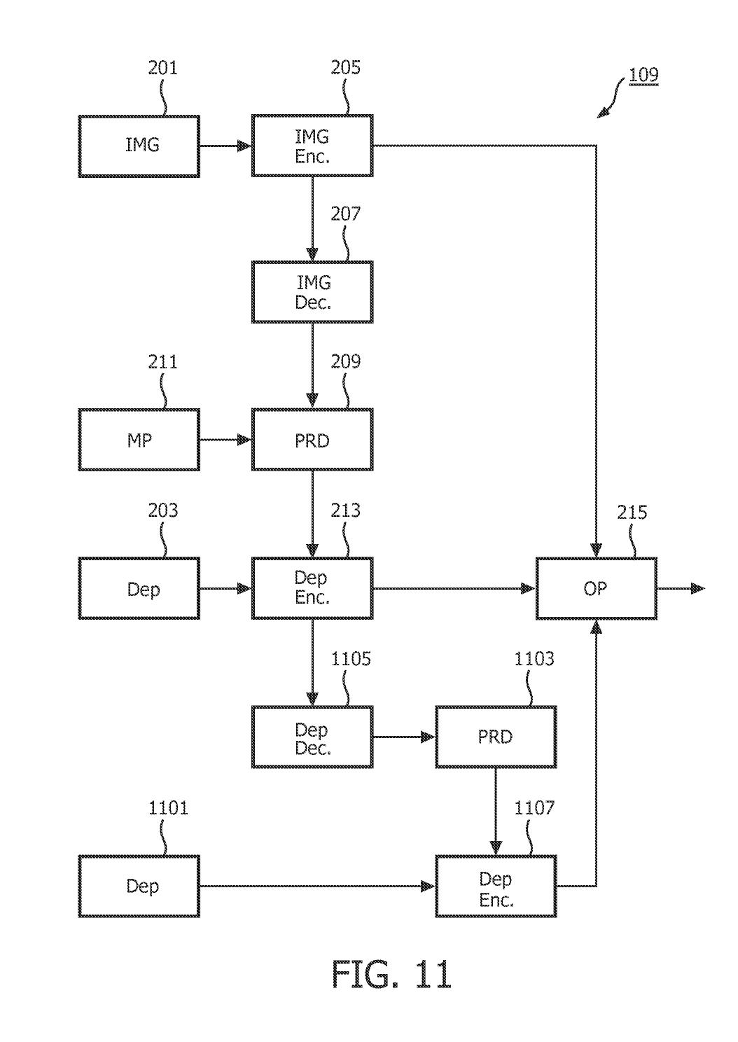

Thus, based on a depth indication map for a first view, a depth indication map for a second view may be encoded. For example, as illustrated in FIG. 11, the encoder of FIG. 2 may be enhanced to provide encoding for stereo depth indication maps. Specifically, the encoder of FIG. 11 corresponds to the encoder of FIG. 2 but further comprises a second receiver 1101 which is arranged to receive a second depth indication map corresponding to a second view. In the following, the depth indication map received by the receiver 203 will be referred to as the first view depth indication map and the depth indication map received by the second receiver 1101 will be referred to as the second view depth indication map. The first and second view depth indication maps are particularly right and left depth indication maps of a stereo image.

The first view depth indication map is encoded as previously described. Furthermore, the encoded first view depth indication map is fed to a view predictor 1103 which proceeds to generate a prediction for the second view depth indication map from the first view depth indication map. Specifically, the system comprises a depth decoder 1105 between the depth encoder 213 and the view predictor 1103 which decodes the encoding data for the first view depth indication map and provides the decoded depth indication map to the view predictor 1103, which then generates a prediction for the second view depth indication map therefrom. In a simple example, the first view depth indication map may itself be used directly as a prediction for the second depth indication map.

The encoder of FIG. 11 further comprises a second depth encoder 1107 which receives the predicted depth indication map from the view predictor 1103 and the original image from the second receiver 1101. The second depth encoder 1107 proceeds to encode the second view depth indication map in response to the predicted depth indication map from the view predictor 1103. Specifically, the second encoder 1107 may subtract the predicted depth indication map from the second view depth indication map and encode the resulting residual depth indication map. The second encoder 1107 is coupled to the output processor 215 which includes the encoded data for the second view depth indication map in the output stream.

The described approach may allow a particularly efficient encoding for multi-view depth indication maps. In particular, a very low data rate for a given quality can be achieved.

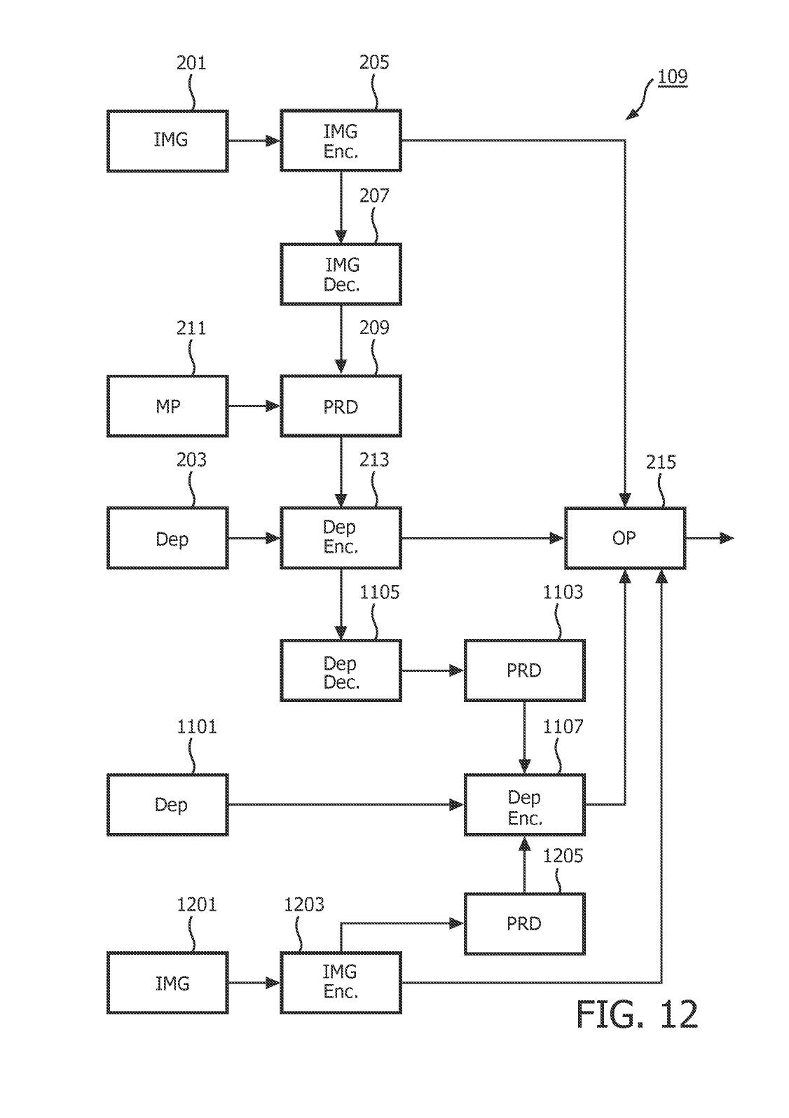

Typically the image for the second view will also be encoded and included in the output stream. Thus, the encoder of FIG. 11 may be enhanced as illustrated in FIG. 12.

Specifically, a receiver 1201 may receive the second view image (e.g. the right image of a stereo image). It may then feed this image to an second image encoder 1203 which proceeds to encode the image. The second image encoder 1203 may be identical to the first image encoder 205 and may specifically perform an encoding of the image in accordance with the H264 standard. The second image encoder 1203 is coupled to the output processor 215 which is fed the encoding data from the second image encoder 1203.

Thus, in the example, the output stream comprises four different data streams:

The encoding data for the first view image. This data is self contained and is not dependent on any other encoding data.

The encoding data for the second view image. This data is self contained and is not dependent on any other encoding data.

The encoding data for the first view depth indication map. This data is encoded in dependence on the encoding data for the first view image.

The encoding data for the second view depth indication map. This data is encoded in dependence on the encoding data for the first view depth indication map and therefore also in dependency on the first view image data.

As illustrated in FIG. 12, the encoding of the second view depth indication map may also be dependent on the second view image. Indeed, in the example, a predictor 1205 generates a prediction depth indication map for the second view depth indication map based on the second view image. This prediction may be generated using the same approach as when predicting the first view depth indication map from the first view image. Thus, the predictor 1205 may be considered to represent the combined functionality of blocks 207, 209 and 211. Indeed, in some scenarios, the exact same mapping may be used.

Thus, in the example of FIG. 12, the second depth encoder 1107 performs an encoding based on two different predictions for the second depth indication map.

In the example of FIG. 12, the two images are decoded independently and self consistently (i.e. without relying or using data from the other encodings). However, in some examples one of the images may further be encoded in dependency on the other image. For example, the second image encoder 1203 may receive the decoded first view image from the image decoder 207 and use this as a prediction for the second view image being encoded.

Different approaches may be used for predicting the second image depth indication map from the first image depth indication map. As mentioned, the first image depth indication map may even in some examples be used directly as the prediction of the second depth indication map.

A particularly efficient and high performance system may be based on the same approach of mapping as described for the mapping between the image and the depth indication map.

Specifically, based on reference maps, a mapping may be generated which relates input data in the form of input sets of image spatial positions and a depth indication values of depth indication values associated with the image spatial positions in a depth indication map associated with a first view to output data in the form of depth indication values in a depth indication map associated with a second view. Thus, the mapping is generated to reflect a relationship between a reference depth indication map for the first view (i.e. corresponding to the first view image) and a corresponding reference depth indication map for the second view (i.e. corresponding to the second view image).

This mapping may be generated using the same principles as previously described for the image to depth indication map mapping. In particular, the mapping may be generated based on depth maps for a previous stereo image. For example, for the previous stereo image depth maps, each spatial position may be evaluated with the appropriate bin of a mapping being identified as the one covering a matching spatial interval and depth value intervals. The corresponding values in the depth indication map for the second view may then be used to generate the output value for that bin (and may in some examples be used directly as the output value). Thus, the approach may provide advantages in line with those of the approach being applied to image to depth mapping including automatic generation of mapping, accurate prediction, practical implementations etc.

A particular efficient implementation of encoders may be achieved by using common, identical or shared elements. In some systems, a predictive encoder module may be used for a plurality of encoding operations.

Specifically, a basic encoding module may be arranged to encode an input image/map based on a prediction of the image/map. The basic encoding module may specifically have the following inputs and outputs:
an encoding input for receiving an image/map to be encoded;
a prediction input for receiving a prediction for the image/map to be encoded; and
an encoder output for outputting the encoded data for the image to be encoded.

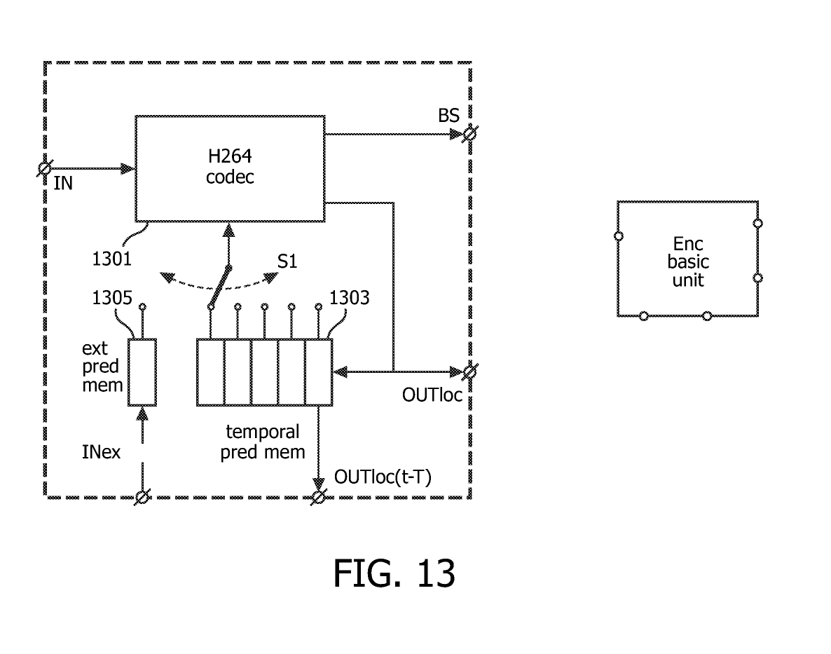

An example of such an encoding module is the encoding module illustrated in FIG. 13. The specific encoding module uses an H264 codec 1301 which receives the input signal IN containing the data for the image or map to be encoded. Further, the H264 codec 1301 generates the encoded output data BS by encoding the input image in accordance with the H264 encoding standards and principles. This encoding is based on one or more prediction images which are stored in prediction memories 1303, 1305. One of these prediction memories 1305 is arranged to store the input image from the prediction input (INex). In particular, the basic encoding module may overwrite prediction images generated by the basic encoding module itself. Thus, in the example, the prediction memories 1303, 1305 are in accordance with the H264 standard filled with previous prediction data generated by decoding of previous encoded images/maps of the video sequence. However, in addition, at leas one of the prediction memories 1305 is overwritten by the input image/map from the prediction input, i.e. by a prediction generated externally. Whereas the prediction data generated internally in the encoding module is typically temporal or spatial predictions i.e. from current, previous or future images/maps of the video sequence, the prediction provided on the prediction input may typically be non-temporal and non-spatial predictions. For example, it may be a prediction based on an image from a different view. For example, the second view image/depth indication map may be encoded using an encoding module as described, with the first view image/depth indication map being fed to the prediction input.

The exemplary encoding module of FIG. 13 further comprises an optional decoded image output OUT_{loc} which can provide the decoded image/map resulting from decoding of the encoded data to external functionality. Furthermore, a second optional output in the form of a delayed decoded image/map output OUT_{locτ-1}) provides a delayed version of the decoded image.

The encoding unit may specifically be an encoding unit as described in WO2008084417, the contents of which is hereby incorporated by reference.

Thus, in some examples the system may encode a video signal wherein compression is performed and multiple temporal predictions are used with multiple prediction frames being stored in a memory, and wherein a prediction frame in memory is overwritten with a separately produced prediction frame.

The overwritten prediction frame may specifically be one or more of the prediction frames longest in memory.

The memory may be a memory in an enhancement stream encoder and a prediction frame may be overwritten with a frame from a base stream encoder.

The encoding module may be used in many advantageous configurations and topologies, and allows for a very efficient yet low cost implementation. For example, in the encoder of FIG. 12, the same encoding module may be used both for the image encoder 205, the depth encoder 213, the second image encoder 1203 and the second HDR encoder 1207.

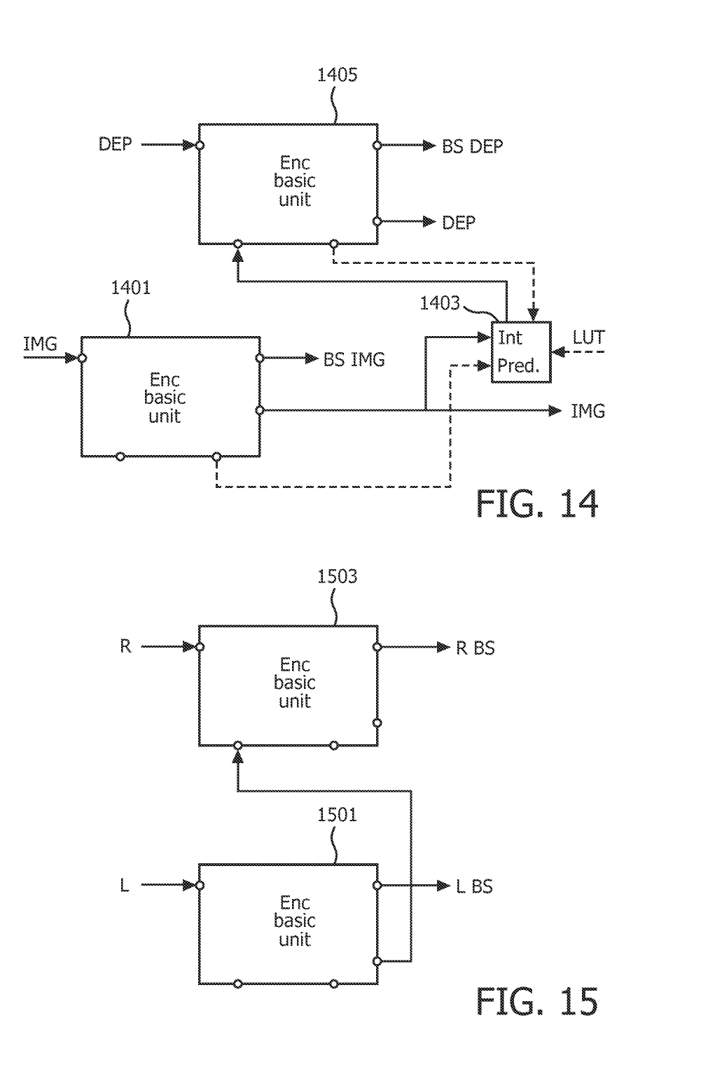

Various advantageous configurations and uses of an encoding module such as that of FIG. 13 will be described with reference to FIGS. 14-17.

FIG. 14 illustrates an example wherein a basic encoding module, such as that of FIG. 13, may be used for encoding of both an image and a corresponding depth indication map in accordance with the previously described principles. In the example, the basic encoding module 1401, 1405 is used both to encode the image and the depth indication map.

In the example, the image is fed to the encoding module 1401 which proceeds to generate an encoded bitstream BS IMG without any prediction for the image being provided on the prediction input (although the encoding may use internally generated predictions, such as temporal predictions used for motion compensation).

The basic encoding module 1401 further generates a decoded version of the image on the decoded image output and a delayed decoded image on the delayed decoded image output. These two decoded images are fed to the predictor 1403 which further receives a delayed decoded image, i.e. a previous image. The predictor 1403 proceeds to generate a mapping based on the previous (delayed) decoded image and depth indication map. It then proceeds to generate a predicted depth indication map for the current image by applying this mapping to the current decoded image.

The basic encoding module 1405 then proceeds to encode the depth indication map on the predicted depth indication map. Specifically, the predicted depth indication map is fed to the prediction input of the basic encoding module 1405 and the depth indication map is fed to the input. The basic encoding module 1405 then generates an output bitstream BS DEP corresponding to the depth indication map. The two bitstreams BS IMG and BS DEP may be combined into a single output bitstream.

In the example, the same encoding module (represented by the two functional manifestations 1401, 1405) is thus used to encode both the image and the depth indication map. This may be achieved using only one basic encoding module time sequentially. Alternatively, identical basic encoding modules can be implemented. This may result in substantial cost saving.

In the example, the depth indication map is thus encoded in dependence on the image whereas the image is not encoded in dependence on the depth indication map. Thus, a hierarchical arrangement of encoding is provided where a joint encoding/compression is achieved.

It will be appreciated that the example of FIG. 14 may be seen as a specific implementation of the encoder of FIG. 2 where identical or the same encoding module is used for the image and the depth indication map. Specifically, the same basic encoding module may be used to implement both the image encoder 205 and image decoder 207 as well as the depth encoder 213 of FIG. 2.

Another example is illustrated in FIG. 15. In this example, a plurality of identical or a single basic encoding module 1501, 1503 is used to perform an efficient encoding of a stereo image. In the example, a left image is fed to a basic encoding module 1501 which proceeds to encode the left image without relying on any prediction. The resulting encoding data is output as first bitstream L BS. Image data for a right image is input on the image data input of a basic encoding module 1503. Furthermore, the left image is used as a prediction image and thus the decoded image output of the basic encoding module 1501 is coupled to the prediction input of the basic encoding module 1503 such that the decoded version of the left image is fed to the prediction input of the basic encoding module 1503 which proceeds to encode the right image based on this prediction. The basic encoding module 1503 thus generates a second bitstream R BS comprising encoding data for the right image (relative to the left image).

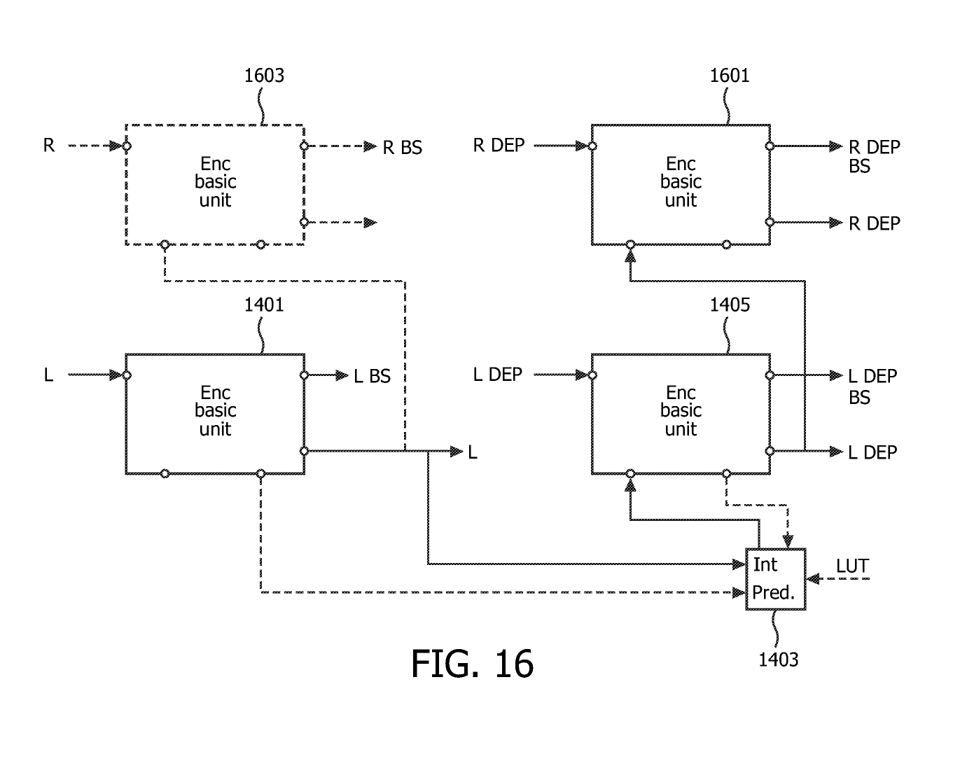

FIG. 16 illustrates an example wherein a plurality of identical or a single basic encoding module 1401, 1403, 1603, 1601 is used to provide a joint and combined encoding of both stereo depth indication maps and images. In the example, the approach of FIG. 14 is applied to a left image and left depth indication map. In addition, a right depth indication map is encoded based on the left depth indication map. Specifically, a right depth indication map is fed to the image data input of a basic encoding module 1601 of which the prediction input is coupled to the decoded image output of the basic encoding module 1405 encoding the left depth indication map. Thus, in the example, the right depth indication map is encoded by the basic encoding module 1601 based on the left depth indication map. Thus, the encoder of FIG. 16 generates a left image bitstream L BS, a left depth indication map bitstream L DEP BS, and a right depth indication map R DEP BS.

In the specific example of FIG. 16, a fourth bitstream is also encoded for a right image. In the example, a basic encoding module 1603 receives a right image on the image data input whereas the decoded version of the left image is fed to the prediction input. The basic encoding module 1603 then proceeds to encode the right image to generate the fourth bitstream R BS.

Thus, in the example of FIG. 15, both stereo image and depth characteristics are jointly and efficiently encoded/compressed. In the example, the left view image is independently coded and the right view image depends on the left image. Furthermore, the left depth indication map depends on the left image. The right depth indication map depends on the left depth indication map and thus also on the left image. In the example the right image is not used for encoding/decoding any of the stereo depth indication maps. An advantage of this is that only 3 basic modules are required for encoding/decoding the stereo depth indication maps.

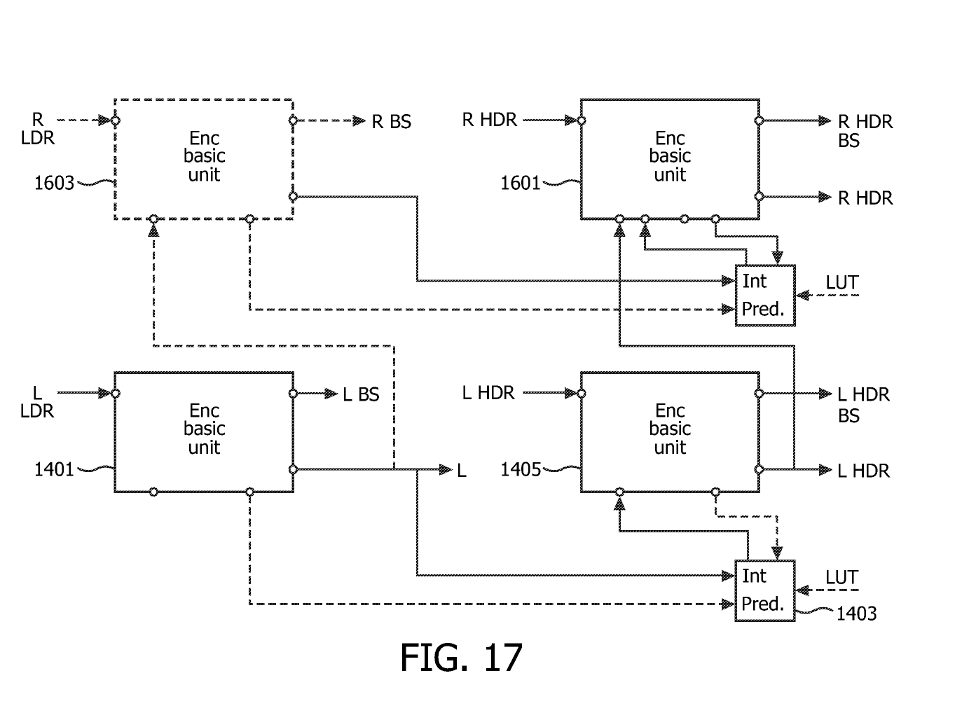

FIG. 17 illustrates an example, wherein the encoder of FIG. 16 is enhanced such that the right image is also used to encode the right depth indication map. Specifically, a prediction of the right depth indication map may be generated from the right image using the same approach as for the left depth indication map. Specifically, a mapping as previously described may be used. In the example, the prediction input of the basic encoding module 1501 is arranged to receive two prediction maps which may both be used for the encoding of the right depth indication map. For example, the two prediction depth indication maps may overwrite two prediction memories of the basic encoding module 1601.

Thus, in this example, both stereo images and depth indication maps are jointly encoded and (more) efficiently compressed. Here, the left view image is independently coded and the right view image is encoded dependent on the left image. In this example, the right image is also used for encoding/decoding the stereo depth indication map signal, and specifically the right depth indication map. Thus, in the example, two predictions may be used for the right depth indication map thereby allowing higher compression efficiency, albeit at the expensive of requiring four basic encoding modules (or reusing the same basic encoding module four times).

Thus, in the examples of FIGS. 14-17, the same basic encoding/compression module is used for joint image and depth map coding, which is both beneficial for compression efficiency and for implementation practicality and cost.

It will be appreciated that FIGS. 14-17 are functional illustrations and may reflect a time sequential use of the same encoding module or may e.g. illustrate parallel applications of identical encoding modules.

The described encoding examples thus generate output data which includes an encoding of one or more images or depth maps based on one or more images or depth maps. Thus, in the examples, at least two maps are jointly encoded such that one is dependent on the other but with the other not being dependent on the first. For example, in the encoder of FIG. 16, the two depth indication maps are jointly encoded with the right depth indication map being encoded in dependence on the left depth indication map (via the prediction) whereas the left depth indication map is independently encoded of the right depth indication map.

This asymmetric joint encoding can be used to generate advantageous output streams. Specifically, the two output streams R DEP BS and L DEP BS for the right and left depth indication maps respectively are generated (split) as two different data streams which can be multiplexed together to form (part of) the output data stream. The L DEP BS data stream which does not require data from the R DEP BS data stream may be considered a primary data stream and the R DEP BS data stream which does require data from the L DEP BS data stream may be considered a secondary data stream. In a particularly advantageous example the multiplexing is done such that the primary and secondary data streams are provided with separate codes. Thus, a different code (header/label) is assigned to the two data streams thereby allowing the individual data streams being separated and identified in the output data stream.

As a specific example, the output data stream may be divided into data packets or segments with each packet/segment comprising data from only the primary or the secondary data stream and with each packet/segment being provided with a code (e.g. in a header, preamble, midamble or postamble) that identifies which stream is included in the specific packet/segment.

Such an approach may allow improved performance and may in particular allow backwards compatibility. For example, a fully compatible stereo decoder may be able to extract both the right and left depth indication maps to generate a full stereo depth indication map. However, a non-stereo decoder can extract only the primary data stream. Indeed, as this data stream is independent of the right depth indication map, the non-stereo decoder can proceed to decode a single depth indication map using non-stereo techniques.

It will be appreciated that the approach may be used for different encoders. For example, for the encoder of FIG. 14, the BS IMG bit stream may be considered the primary data stream and the BS DEP bit stream may be considered the secondary data stream. In the example of FIG. 15, the L BS bit stream may be considered the primary data stream and the R BS bit stream may be considered the secondary data stream. Thus, in some examples, the primary data stream may comprise data which is fully self contained, i.e. which does not require any other encoding data input (i.e. which is not dependent on encoding data from any other data stream but is encoded self consistently).

Also, the approach may be extended to more than two bit streams. For example, for the encoder of FIG. 16, the L BS bitstream (which is fully self contained) may be considered the primary data stream, the L DEP BS (which is dependent on the L BS bitstream but not on the R DEP BS bitstream) may be considered the secondary data stream, and the R DEP BS bitstream (which is dependent on both the L BS and the L DEP BS bitstream) may be considered a tertiary data stream. The three data streams may be multiplexed together with each data stream being allocated its own code.

As another example, the four bit streams generated in the encoder of FIG. 16 or 17 may be included in four different parts of the output data stream. As a specific example, the multiplexing of the bit streams may generate an output stream including the following parts: part1 containing all L BS packets with descriptor code 0x1B (regular H264), part2 containing all R BS packets with descriptor code 0x20 (the dependent stereo view of MVC), part3 containing all L DEP BS packets with descriptor code 0x21 and part 4 containing all R DEP BS enh packets with descriptor code 0x22. This type of multiplexing allows for flexible usage of the stereo multiplex while maintaining the backward compatibility. In particular, the specific codes allows a traditional H264 decoder decoding a single image while allowing suitably equipped (e.g. H264 or MVC based) decoders to decode more advanced images and depth maps, such as the stereo images/maps.

The generation of the output stream may specifically follow the approach described in WO2009040701 which is hereby incorporated by reference.

Such approaches may combine the advantages of other methods while avoiding their respective drawbacks. The approach comprises jointly compressing two or more video data signals, followed by forming two or more (primary and secondary) separate bit-streams. A primary bit stream that is self-contained (or not dependent on the secondary bit stream) and can be decoded by decoders that may not be capable of decoding both bit streams. The separate bit streams are multiplexed wherein the primary and secondary bit-streams are separate bit streams provided with separate codes and transmitted. Prima facie it may seem superfluous and a waste of effort to first jointly compress signals only to split them again after compression and having them provided with separate codes. In common techniques the compressed data signal is given a single code in the multiplexer. Prima facie the approach seems to add an unnecessary complexity in the encoding of the data signal.

However it has been realized that splitting and separately packaging (i.e. giving the primary and secondary bit stream separate codes in the multiplexer) of the primary and secondary bit stream in the multiplexed signal has the result that, on the one hand, a standard demultiplexer in a conventional video system will recognize the primary bit stream by its code and send it to the decoder so that the standard video decoder receives only the primary stream, the secondary stream not having passed the de-multiplexer, and the standard video decoder is thus able to correctly process it as a standard video data signal, while on the other hand a specialized system can completely reverse the encoding process and re-create the original enhanced bit-stream before sending it to a suitable decoder.

In the approach the primary and secondary bit streams are separate bit streams wherein the primary bit stream may specifically be a self-contained bit stream. This allows the primary bit stream to be given a code corresponding to a standard video data signal while giving the secondary bit stream or secondary bit streams codes that will not be recognized by standard demultiplexers as a standard video data signal. At the receiving end, standard demultiplexing devices will recognize the primary bit stream as a standard video data signal and pass it on to the video decoder. The standard demultiplexing devices will reject the secondary bit-streams, not recognizing them as standard video data signals. The video decoder itself will only receive the “standard video data signal”. The amount of bits received by the video decoder itself is thus restricted to the primary bit stream which may be self-contained and in the form of a standard video data signal and is interpretable by standard video devices and having a bitrate which standard video devices can cope with.

The coding can be characterized in that a video data signal is encoded with the encoded signal comprising a first and at least a second set of frames, wherein the frames of the first and second set are interleaved to form an interleaved video sequence, or in that an interleaved video data signal comprising a first and second set of frames is received, wherein the interleaved video sequence is compressed into a compressed video data signal, wherein the frames of the first set are encoded and compressed without using frames of the second set, and the frames of the second set are encoded and compressed using frames of the first set, and where after the compressed video data signal is split into a primary and at least a secondary bit-stream each bit-stream comprising frames, wherein the primary bit-stream comprises compressed frames for the first set, and the secondary bit-stream for the second set, the primary and secondary bit-streams forming separate bit streams, where after the primary and secondary bit streams are multiplexed into a multiplexed signal, the primary and secondary bit stream being provided with separate codes.

After the interleaving at least one set, namely the set of frames of the primary bit-stream, may be compressed as a “self-contained” signal. This means that the frames belonging to this self-contained set of frames do not need any info (e.g. via motion compensation, or any other prediction scheme) from the other secondary bit streams.

The primary and secondary bit streams form separate bit streams and are multiplexed with separate codes for reasons explained above.

In some examples, the primary bit stream comprises data for frames of one view of a multi-view video data signal and the secondary bit stream comprises data for frames of another view of a multi-view data signal.

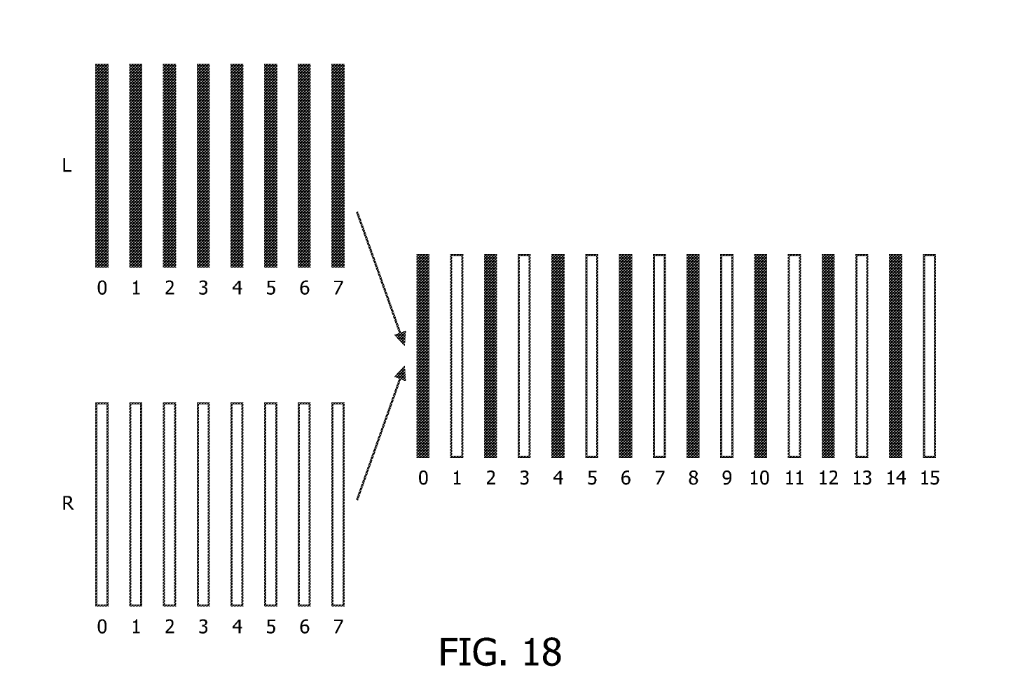

FIG. 17 illustrates an example of possible interleaving of two views, (such as the left (L) depth indication map and right (R) depth indication map), each comprised of frames 0 to 7, into an interleaved combined signal having frames 0 to 15 (see FIG. 18).

In the specific example, the frames/maps of the L DEP BS and the R DEP BS of FIG. 16 are divided into individual frames/segments as shown in FIG. 17.

The frames of the left and right view depth indication maps are then interleaved to provide a combined signal. The combined signal resembles a two dimensional signal. A special feature of the compression is that the frames of one of the views is not dependent on the other (and may be a self-contained system), i.e. in compression no information from the other view is used for the compression. The frames of the other view are compressed using information from frames of the first view. The approach departs from the natural tendency to treat two views on an equal footing. In fact, the two views are not treated equally during compression. One of the views becomes the primary view, for which during compression no information is used form the other view, the other view is secondary. The frames of the primary view and the frames of the secondary view are split into a primary bit-stream and a secondary bit stream. The coding system can comprise a multiplexer which assigns a code, e.g. 0x01 for MPEG or 0x1B for H.264, to the primary bit stream and a different code, e.g. 0x20, to the secondary stream. The multiplexed signal is then transmitted. The signal can be received by a decoding system where a demultiplexer recognizes the two bit streams 0x01 or 0x1B (for the primary stream) and 0x20 (for the secondary stream) and sends them both to a bit stream merger which merges the primary and secondary stream again and the combined video sequence is then decoded by reversing the encoding method in a decoder. This allows backwards compatibility. Older or less capable decoders can ignore some of the interleaved packets with particular codes (e.g they want to only extract left and right views, but not depth maps or partial images containing background information which may all be interleaved in the stream), whereas the fully capable decoders will decode all packets with their particular interrelationships.

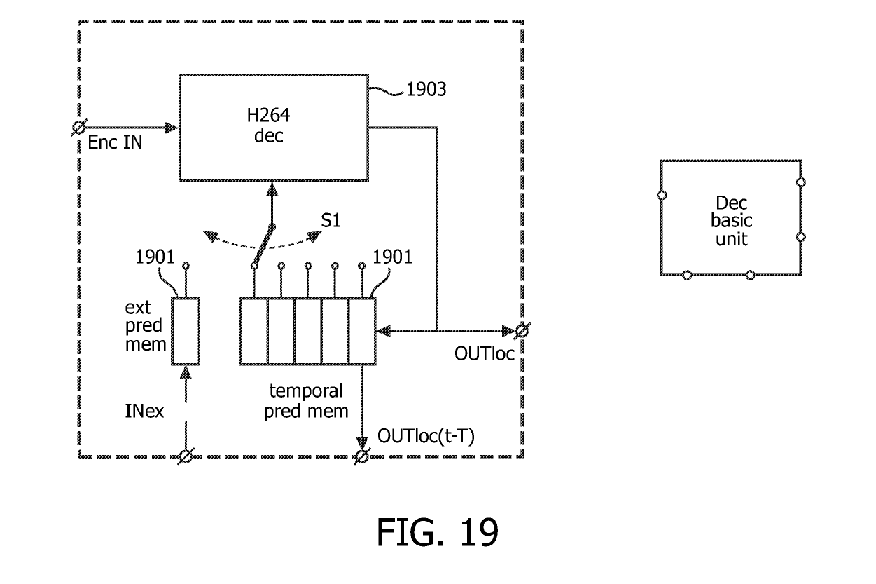

It will be appreciated that the encoder examples of FIGS. 14-17 can directly be transferred to the corresponding operations at the decoder end. Specifically, FIG. 19 illustrates a basic decoding module which is a decoding module complementary to the basic encoding module of FIG. 13. The basic decoding module has an encoder data input for receiving encoder data for an encoded image/depth map which is to be decoded. Similarly to the basic encoding module, the basic decoding module comprises a plurality of prediction memories 1901 as well as a prediction input for receiving a prediction for the encoded image/depth map that is to be decoded. The basic decoding module comprises a decoder unit 1903 which decodes the encoding data based on the prediction(s) to generate a decoded image/depth map which is output on the decoder output OUT_{loc}. The decoded image/map is further fed to the prediction memories. As for the basic encoding module, the prediction data on the prediction input may overwrite data in prediction memories 1901. Also, similarly to the basic encoding module, the basic decoding module has an (optional) output for providing a delayed decoded image/map.

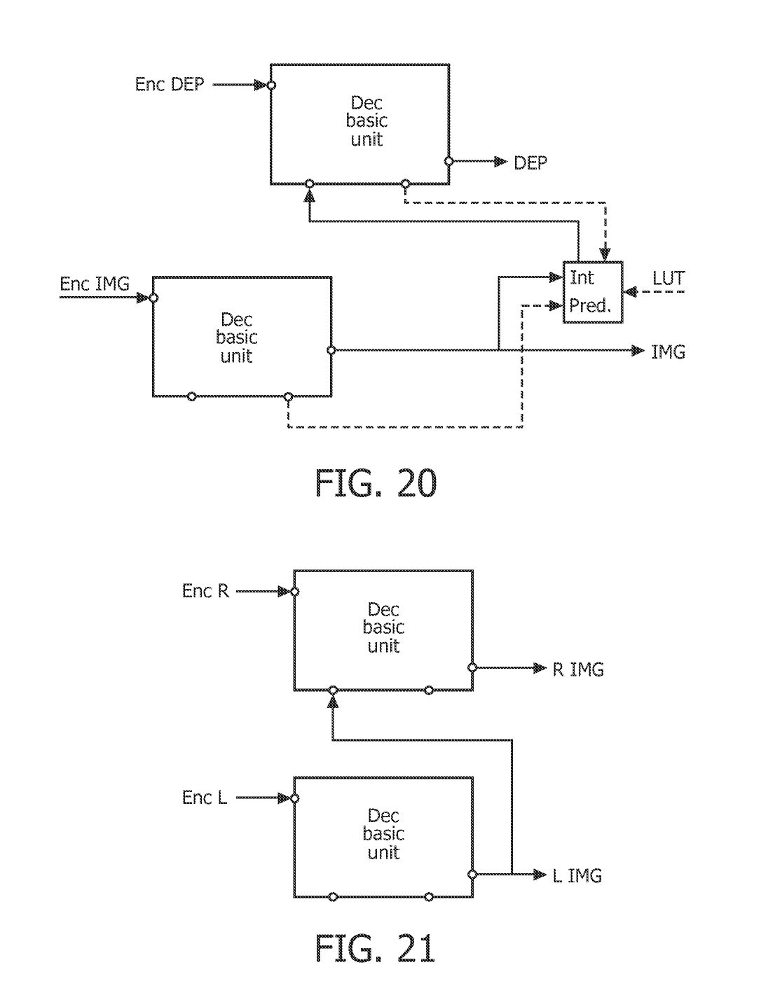

It will be clear that such a basic decoding module can be used complementary to the basic encoding module in the examples of FIG. 14-17. For example, FIG. 20 illustrates a decoder complementary to the encoder of FIG. 14. A multiplexer (not shown) separates the image encoding data Enc IMG and the depth indication map encoding data Enc DEP. A first basic decoding module decodes the image and uses this to generate a prediction for the depth indication map as explained for FIG. 14. A second basic decoding module (identical to the first basic decoding module or indeed the first basic decoding module used in time sequential fashion) then decodes the depth indication map from the depth indication map encoding data and the prediction.

As another example. FIG. 21 illustrates an example of a complementary decoder to the encoder of FIG. 15. In the example, encoding data for the left image is fed to a first basic decoding module which decodes the left image. This is further fed to the prediction input of a second basic decoding module which also receives encoding data for the right image and which proceeds to decode this data based on the prediction thereby generating the right image.

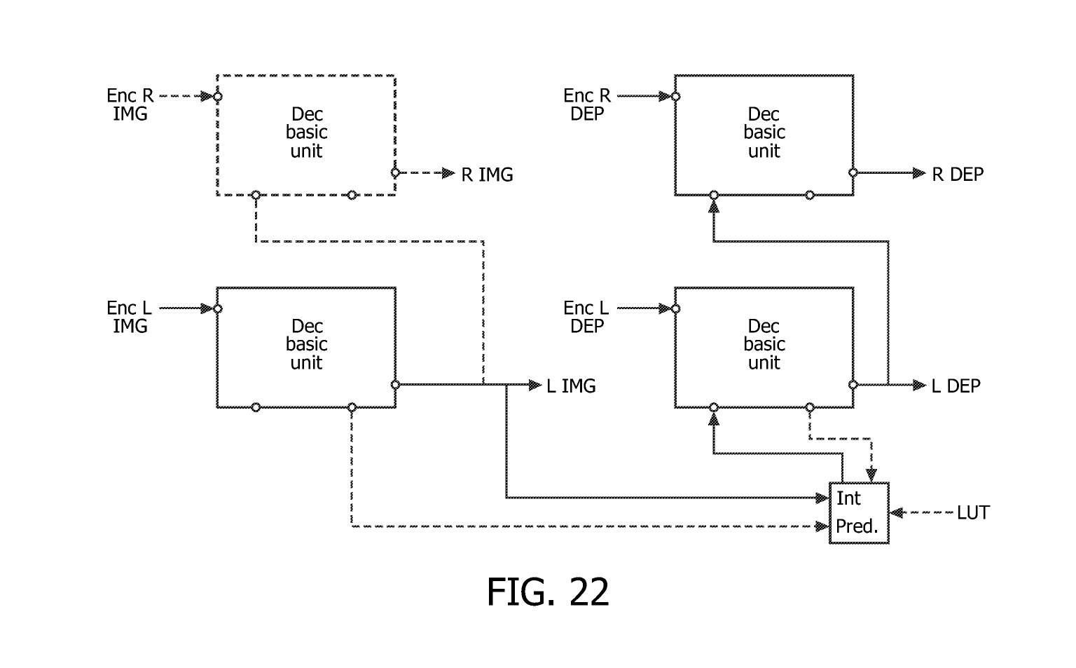

As yet another example, FIG. 22 illustrates an example of a complementary decoder to the encoder of FIG. 16.

It will be appreciated that FIGS. 20-22 are functional illustrations and may reflect a time sequential use of the same decoding module or may e.g. illustrate parallel applications of identical decoding modules.

In the examples, a simple image was considered and a depth indication map was generated for the image based on the image. In some cases, occlusion information may also be provided for the image. For example, the image may be a layered image wherein lower layers provide image data for pixels that are occluded in the normal view. In such cases, the described approach may be used to generate a depth map for occlusion data. For example, a mapping may be generated for the first layer, the second layer etc of a previous layered image. For the current image, the appropriate mapping may be applied to each layer to generate a depth map for each layer. The approach may for example be used in an encoding process wherein predictions for each layer depth indication map is generated in this fashion. The resulting prediction may then for each layer be compared to an input depth indication map for the layer provided by the image source, and the difference may be encoded. The provision of occlusion data may allow improved generation of images from different viewpoints and may in particular allow an improved rendering of de-occluded image objects when the view point is changed.

In the previously described examples, a depth indication map was generated or predicted based on the corresponding image. However, it will be appreciated that the generation or prediction of the depth indication map may also consider other data and indeed may be based on other predictions. For example, the depth indication map for a current image may also be predicted based on depth indication maps generated for previous frames or images. For example, for a given image a mapping may be used to generate a first depth indication map from the image. In addition, a second depth indication map may be generated e.g. directly as the depth indication map from the previous image or e.g. by applying a mapping thereto. A single depth indication map (which specifically may be a predicted depth indication map for the current image) may then be generated, e.g. by selecting image areas from the first and second image depth indication maps that most closely correspond to the input depth indication map. Information of the selection can then be included in the encoded data stream. It will be appreciated that such an approach can be applied to both (all) views in a multi-view image or only to a subset of the views.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way.

Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A method of encoding a depth indication map associated with an image, the method comprising:
receiving the depth indication map;
generating a mapping relating input data in the form of input sets of image spatial positions and one or more parameters generated from color coordinates of pixel values associated with the image spatial positions to output data in the form of depth indication values in response to a reference image and a corresponding reference depth indication map; and
generating an output encoded data stream by encoding the depth indication map in response to the mapping.

2. The method of claim 1 further comprising:
receiving the image;
predicting a predicted depth indication map from the image in response to the mapping;
generating a residual depth indication map in response to the predicted depth indication map and the image;
encoding the residual depth indication map to generate encoded depth data; and
including the encoded depth data in the output encoded data stream.

3. The method of claim 1 wherein the image is an image of a video sequence and the method comprises generating the mapping using a previous image of the video sequence as the reference image and a previous depth indication map generated for the previous image as the reference depth indication map.

4. The method of claim 1 wherein each input set corresponds to a spatial interval for each spatial image dimension and at least one value interval for the one or more parameters, and the generation of the mapping comprises for each image position of at least a group of image positions of the reference image:
determining at least one matching input set having spatial intervals corresponding to the each image position and a value interval for the one or more parameters corresponding to a parameter value for the each image position in the image; and
determining an output depth indication value for the matching input set in response to a depth indication value for the each image position in the reference depth indication map.

5. The method of claim 1 wherein the mapping is at least one of:
a spatially subsampled mapping;
a temporally subsampled mapping; and
a combination value subsampled mapping.

6. The method of claim 1 further comprising:
receiving the image;
generating a prediction for the depth indication map from the image in response to the mapping; and
adapting at least one of the mapping and a residual depth indication map in response to a comparison of the depth indication map and the prediction.

7. The method of claim 1 wherein the image is the reference image and the reference depth indication map is the depth indication map.

8. The method of claim 1 further comprising encoding the image and wherein the image and the depth indication map are jointly encoded with the image being encoded without being dependent on the depth indication map and the depth indication map being encoded using data from the image, the encoded data being split into separate data streams including a primary data stream comprising data for the image and a secondary data stream comprising data for the depth indication map, wherein the primary and secondary data streams are multiplexed into the output encoded data stream with data for the primary and secondary data streams being provided with separate codes.

9. A method of generating a depth indication map for an image, the method comprising:
receiving the image;
providing a mapping relating input data in the form of input sets of image spatial positions and one or more parameters generated from pixel values associated with the image spatial positions to output data in the form of depth indication values, the mapping reflecting a relationship between a reference image and a corresponding reference depth indication map; and
generating the depth indication map in response to the image and the mapping.

10. The method of claim 9 wherein generating the depth indication map comprises determining at least part of a predicted depth indication map by for each position of at least part of the predicted depth indication map:
determining at least one matching input set matching the each position and a first parameter generated from color coordinates of pixel values associated with the each position,
retrieving from the mapping at least one output depth indication value for the at least one matching input set, and
determining a depth indication value for the each position in the predicted depth indication map in response to the at least one output depth indication value; and
determining the depth indication map in response to the at least part of the predicted depth indication map.

11. The method of claim 9 wherein the image is an image of a video sequence and the method comprises generating the mapping using a previous image of the video sequence as the reference image and a previous depth indication map generated for the previous image as the reference depth indication map.

12. The method of claim 11 wherein the previous depth indication map is further generated in response to residual depth data for the previous depth indication map relative to predicted depth data for the previous image.

13. The method of claim 9 wherein the image is an image of a video sequence, and the method further comprises using a nominal mapping for at least some images of the video sequence.

14. The method of claim 9 wherein the one or more parameters is indicative of at least one of a texture, gradient, and spatial pixel value variation for the image spatial positions.

15. The method of claim 9 wherein the depth indication map is associated with a first view image of a multi-view image and the method further comprises:
generating a further depth indication map for a second view image of the multi-view image in response to the depth indication map.

16. A device for encoding a depth indication map associated with an image, the device comprising:
a receiver for receiving the depth indication map;
a mapping generator for generating a mapping relating input data in the form of input sets of image spatial positions and a one or more parameters generated from color coordinates of pixel values associated with the image spatial positions to output data in the form of depth indication values in response to a reference image and a corresponding reference depth indication map; and
an output processor for generating an output encoded data stream by encoding the depth indication map in response to the mapping.

17. An apparatus comprising
the device of claim 16;
input connection means for receiving a signal comprising the depth indication map and feeding it to the device and
output connection means for outputting the output encoded data stream from the device.

18. A device for generating a depth indication map for an image, the device comprising:
a receiver for receiving the image;
a mapping processor for providing a mapping relating input data in the form of input sets of image spatial positions and one or more parameters generated from color coordinates of pixel values associated with the image spatial positions to output data in the form of depth indication values, the mapping reflecting a relationship between a reference image and a corresponding reference depth indication map; and
an image generator for generating the depth indication map in response to the image and the mapping.

19. An apparatus comprising:
the device of claim 18;
input connection means for receiving the image and feeding it to the device;
output connection means for outputting a signal comprising the depth indication map from the device.

20. An encoded signal comprising:
an encoded image; and
residual depth data for a depth indication map, at least part of the residual depth data being indicative of a difference between a desired depth indication map for the image and a predicted depth indication map resulting from application of a mapping to the encoded image, where the mapping relates input data in the form of input sets of image spatial positions and one or more parameters generated from pixel values associated with the image spatial positions to output data in the form of depth indication values, the mapping reflecting a relationship between a reference image and a corresponding reference depth indication map.

21. A storage medium comprising the encoded signal of claim 20.
